(19) United States
(12) Patent Application Publication
(10) Pub. No.: US 2024/0064847 A1
(43) Pub. Date: Feb. 22, 2024

(54) A METHOD OF A RADIO ACCESS NETWORK (RAN) NODE, A METHOD OF A CORE NETWORK NODE, A RADIO ACCESS NETWORK (RAN) NODE, AND A CORE NETWORK NODE

(71) Applicant: NEC Corporation, Minato-ku, Tokyo (JP)

(72) Inventors: Kundan Tiwari, Tokyo (JP); Toshiyuki Tamura, Tokyo (JP)

(73) Assignee: NEC Corporation, Minato-ku, Tokyo (JP)

(21) Appl. No.: 18/270,805

(22) PCT Filed: Dec. 24, 2021
(86) PCT No.: PCT/JP2021/048189

§ 371 Date: Jul. 3, 2023

(30) Foreign Application Priority Data
Jan. 7, 2021 (IN) 202111000766

(51) Int. Cl. H04W 76/20; H04W 28/06

(52) U.S. Cl. CPC H04W 76/20; H04W 28/06

(57) ABSTRACT

This disclosure defines a procedure to handle threat related to replaying of a SUCI in the 5G system. More specifically how to detect and mitigate the man in the middle base station replaying a captured SUCI to trace the UE.

### TECHNICAL FIELD

This disclosure defines a procedure to handle threat related to replaying of a SUCI in the 5G system. More specifically how to detect and mitigate the man in the middle base station replaying a captured SUCI to trace the UE.

### BACKGROUND ART

In the Study on authentication enhancements in 5GS by the 3GPP SA3 working group, the key issue on SUCI replay attacks is identified. A specific SUCI linkability attack and a Denial of Service (DoS) attack related to SUCI replay are outlined in this study.

A subscription concealed identifier is a one-time use subscription identifier, called the subscription Concealed Identifier (SUCI), which contains the Scheme-Output, and additional non-concealed information needed for home network routing and protection scheme usage. When the UE has no temporary mobile identifier (e.g. 5G-GUTI) the UE conceals the SUPI as defined in 3GPP TS 33.501 to a SUCI and sends the SUCI in the registration request message. The 5GS on receiving the registration request message will executes following procedure.

The FIG. 1 illustrates the initiation of authentication procedure and selection of authentication method. The authentication method that to be applied to the UE is selected by the UDM.

The FIG. 2 illustrates the 5G AKA based primary authentication and key agreement procedure.

When a UE sends a SUCI in the registration request message the UE starts a timer T3519. When the T3519 is running the UE sends same SUCI in a case where a registration request message is retransmitted. After the expiry of the timer T3519 the UE deletes the SUCI. When a new SUCI is needed to transmit in a registration request message the UE will calculate a new SUCI, start the timer T3519 and sends the new SUCI in the registration request message. The same procedure can be applied when the identification procedure is triggered to fetch a SUCI from the UE.

Man in the Middle (MITM): MITM is a kind of relay node. It includes a fake Radio Access Network Node and a fake UE. For example, the fake RAN node includes a fake base station or a fake gNB. The fake RAN of the MITM creates a fake cell and lets the UE camp on this cell and captures Access Stratum (AS) messages and Non-Access Stratum (NAS) messages. The fake UE of the MITM modifies the content of the captured AS or NAS message by the fake RAN of the MITM and transmits the AS and NAS message to the legitimate RAN of a PLMN.

### CITATION LIST

### Non Patent Literature

NPL 1: 3GPP TR 21.905: “Vocabulary for 3GPP Specifications”. V16.0.0 (2019-06)
NPL 2: 3GPP TS 23.501: “System architecture for the 5G System (5G5)”. V16.7.0 (2020-12)
NPL 3: 3GPP TS 23.502: “Procedures for the 5G System (5G5)”. V16.7.0 (2020-12)
NPL 4: 3GPP TS 24.501: “Non-Access-Stratum (NAS) protocol for 5G System (5GS); Stage 3”. V16.7.0 (2020-12) NPL 5: 3GPP TS 33.501: “Security architecture and procedures for 5G system” V16.5.0 (2020-12)
NPL 6: 3GPP TS 33.102: “3G Security; Security architecture” V16.0.0 (2020-07)
NPL 7: 3GPP TS 24.301: “Non-Access-Stratum (NAS) protocol for Evolved Packet System (EPS)” V16.7.0 (2020-12)
NPL 8: 3GPP TS 29.272: “Evolved Packet System (EPS); Mobility Management Entity (MME) and Serving GPRS Support Node (SGSN) related interfaces based on Diameter protocol” V16.5.0 (2020-12)

### SUMMARY OF INVENTION

### Technical Problem

As there are strong market needs to fix the SUCI replay attack, a complete solution is required against this security threat in order to make the 3GPP system more secure.

A fake base station (Man in the Middle) captures the SUCI (e.g. SUCI 1) of a UE when the UE is performing registration procedure with a SUCI. The hacker installs a fake base station at some other place or same place. The fake base station traps the initial NAS message of a UE and corrupts the 5G-GUTI of the UE sent in the initial NAS message e.g. Registration Request message (i.e. the fake base station sends 5G-GUTI 2 instead of 5G-GUTI 1). The 5GC does not find the UE context corresponding to the 5G-GUTI 2 and sends Identity Request message to get a SUCI of the UE. The UE transmits a SUCI (e.g. SUCI 2) in the Identity response message. The Man in the Middle traps the identity response message and replaces SUCI 2 with SUCI 1. The Man in the Middle sends the Identity response message including SUCI 1, and the 5GC receives the Identity response message including SUCI 1. Then the 5GC initiates the authentication procedure by using SUCI 1. If the authentication procedure using SUCI 1 is completed successfully, the hacker can know a location of the UE sending the initial NAS message and time when UE sends the initial NAS message. For example the hacker can know that the UE locates near the fake base station. In addition, when the Man in the Middle corrupts the 5G-GUTI in the initial NAS message which is sent by the each UE in the cell of the fake base station, the 5GC sends a lot of identity response messages and initiates a lot of authentication procedures. This raises a DoS attack on the 5GC and the UE respectively.

### Solution to Problem

A method of a Radio Access Network (RAN) node, according to one disclosure includes receiving a Radio Resource Control (RRC) message. The RRC message includes a first identifier and a Non-Access-Stratum (NAS) message. The NAS message includes a second identifier. The method includes comparing the first identifier and the second identifier. The method includes discarding the RRC message in a case where the first identifier is different from the second identifier.

A method of a core network node, according to one disclosure includes receiving a message. The message includes a first identifier and a Non-Access-Stratum (NAS) message. The NAS message includes a second identifier. The method includes comparing the first identifier and the second identifier. The method includes discarding the NAS message in a case where the first identifier is different from the second identifier.

A method of a core network node, according to one disclosure includes storing a first identifier. The method includes receiving a message during a NAS procedure. The message includes a second identifier. The method includes comparing the first identifier and the second identifier. The method includes aborting the NAS procedure in a case where the first identifier corresponds to the second identifier.

A method of a core network node, according to one disclosure includes receiving a first identifier. The method includes starting a timer. The method includes receiving a second identifier. The method includes determining whether the second identifier is sent after the timer expires. The method includes sending a message to reject a NAS procedure in a case of determining that the second identifier is sent after the timer expires.

A method of a core network node, according to one disclosure includes receiving a first identifier. The method includes starting a timer. The method includes receiving a second identifier. The method includes determining whether the second identifier is sent within a timer value of the timer. The method includes sending a message to reject a NAS procedure in a case of determining that the second identifier is sent within the timer value of the timer.

A method of a core network node, according to one disclosure includes receiving a first identifier. The method includes starting a timer. The method includes determining whether the timer expires. The method includes sending a message to reject a NAS procedure in a case of determining that the timer expires.

A method of a core network node, according to one disclosure includes storing a first identifier. The method includes starting a timer. The method includes receiving a message during an authentication procedure. The message includes a second identifier. The method includes determining whether the first identifier corresponds to the second identifier and the timer is running. The method includes rejecting the authentication procedure in a case of determining that the first identifier corresponds to the second identifier and the timer is not running.

A Radio Access Network (RAN) node according to one disclosure includes means for receiving a Radio Resource Control (RRC) message. The RRC message includes a first identifier and a Non-Access-Stratum (NAS) message. The NAS message includes a second identifier. The RAN node includes means for comparing the first identifier and the second identifier. The RAN node includes means for discarding the RRC message in a case where the first identifier is different from the second identifier.

A core network node according to one disclosure includes means for receiving a message. The message includes a first identifier and a Non-Access-Stratum (NAS) message. The NAS message includes a second identifier. The core network node includes means for comparing the first identifier and the second identifier. The core network node includes means for discarding the NAS message in a case where the first identifier is different from the second identifier.

A core network node according to one disclosure includes means for storing a first identifier. The core network node includes means for receiving a message during a NAS procedure. The message includes a second identifier. The core network node includes means for comparing the first identifier and the second identifier. The core network node includes means for aborting the NAS procedure in a case where the first identifier corresponds to the second identifier.

A core network node according to one disclosure includes means for receiving a first identifier. The core network node includes means for starting a timer. The core network node includes means for receiving a second identifier. The core network node includes means for determining whether the second identifier is sent after the timer expires. The core network node includes means for sending a message to reject a NAS procedure in a case of determining that the second identifier is sent after the timer expires.

A core network node according to one disclosure includes means for receiving a first identifier. The core network node includes means for starting a timer. The core network node includes means for receiving a second identifier. The core network node includes means for determining whether the second identifier is sent within a timer value of the timer. The core network node includes means for sending a message to reject a NAS procedure in a case of determining that the second identifier is sent within the timer value of the timer.

A core network node according to one disclosure includes means for receiving a first identifier. The core network node includes means for starting a timer. The core network node includes means for determining whether the timer expires. The core network node includes means for sending a message to reject a NAS procedure in a case of determining that the timer expires.

A core network node according to one disclosure includes means for storing a first identifier. The core network node includes means for starting a timer. The core network node includes means for receiving a message during an authentication procedure. The message includes a second identifier. The core network node includes means for determining whether the first identifier corresponds to the second identifier. The core network node includes means for determining whether the timer is running. The core network node includes means for rejecting the authentication procedure in a case of determining that the first identifier corresponds to the second identifier and the timer is not running.

### BRIEF DESCRIPTION OF DRAWINGS

FIG. 1 illustrates the initiation of authentication procedure and selection of authentication method.

FIG. 2 illustrates the 5G AKA based primary authentication and key agreement procedure.

FIG. 3 illustrates procedure for detection and handling of corrupt NAS message at the (R)AN.

FIG. 4 illustrates procedure for detection and handling of corrupt NAS message at the AMF.

FIG. 5 illustrates procedure for detection and handling of corrupt NAS message at the AMF.

FIG. 6 illustrates procedure for detection and handling of corrupt NAS message at the UDM.

FIG. 7 is a block diagram illustrating the main components of the UE.

FIG. 8 is a block diagram illustrating the main components of an exemplary (R)AN node.

FIG. 9 is a block diagram illustrating the main components of the AMF.

FIG. 10 illustrates the initiation of authentication procedure and selection of authentication method.

FIG. 11 illustrates the initiation of authentication procedure and selection of authentication method.

FIG. 12 illustrates procedure for RRC connection establishment, successful.

FIG. 13 illustrates procedure for RRC connection establishment, network reject.

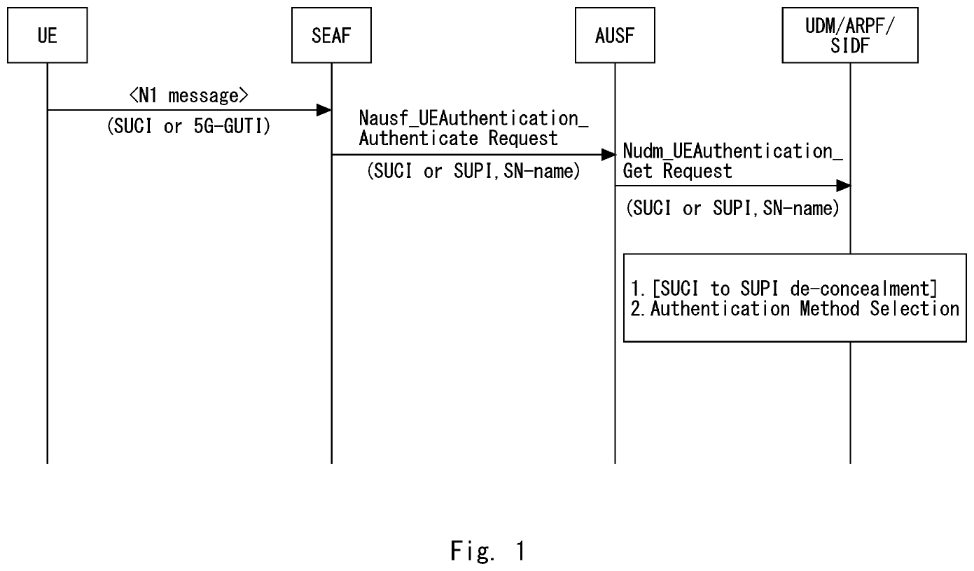

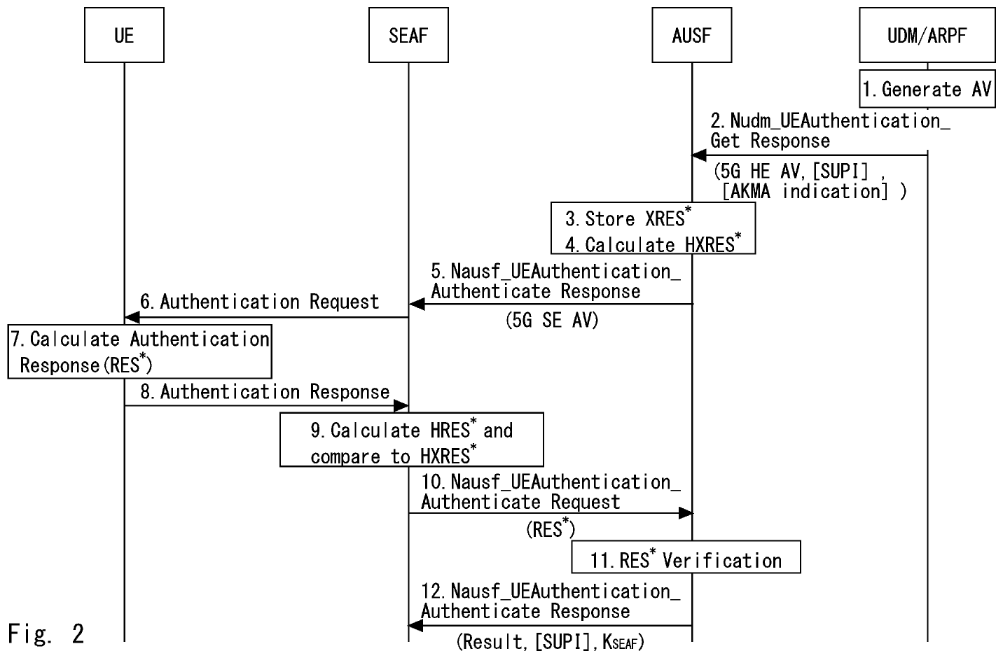

### DESCRIPTION OF EMBODIMENTS

### Abbreviations

For the purposes of the present document, the abbreviations given in 3GPP TR 21.905 (NPL1) and the following apply. An abbreviation defined in the present document takes precedence over the definition of the same abbreviation, if any, in 3GPP TR 21.905 (NPL1).
4G-GUTI 4G Globally Unique Temporary UE Identity
5GC 5G Core Network
SGLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QoS Identifier
AF Application Function
AMF Access and Mobility Management Function
AS Access Stratum
ATSSS Access Traffic Steering, Switching, Splitting
ATSSS-LL ATSSS Low-Layer
AUSF Authentication Server Function
AUTN Authentication token
BMCA Best Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Plane
DAPS Dual Active Protocol Stacks
DL Downlink
DN Data Network
DNAI DN Access Identifier
DNN Data Network Name
DRX Discontinuous Reception
DS-TT Device-side TSN translator
ePDG evolved Packet Data Gateway
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
GPSI Generic Public Subscription Identifier
GUAMI Globally Unique AMF Identifier
GUTI Globally Unique Temporary UE Identity
HR Home Routed (roaming)
IAB Integrated access and backhaul
IMEI/TAC IMEI Type Allocation Code
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
MCC Mobile country code
MCX Mission Critical Service
MDBV Maximum Data Burst Volume
MFBR Maximum Flow Bit Rate
MICO Mobile Initiated Connection Only
MITM Man In the Middle
MNC Mobile Network Code
MPS Multimedia Priority Service
MPTCP Multi-Path TCP Protocol
N3IWF Non-3GPP InterWorking Function
NSCW Non-5G-Capable over WLAN
NAI Network Access Identifier
NEF Network Exposure Function
NF Network Function
NGAP Next Generation Application Protocol
NID Network identifier
NPN Non-Public Network
NR New Radio
NRF Network Repository Function
NSI ID Network Slice Instance Identifier
NSSAA Network Slice-Specific Authentication and Authorization
NSSAAF Network Slice-Specific Authentication and Authorization
Function
NSSAI Network Slice Selection Assistance Information
NSSF Network Slice Selection Function
NSSP Network Slice Selection Policy
NW-TT Network-side TSN translator
NWDAF Network Data Analytics Function
PCF Policy Control Function
PDB Packet Delay Budget
PDR Packet Detection Rule
PDU Protocol Data Unit
PEI Permanent Equipment Identifier
PER Packet Error Rate
PFD Packet Flow Description
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QoE Quality of Experience
RACS Radio Capabilities Signalling optimisation
(R)AN (Radio) Access Network
RG Residential Gateway
RIM Remote Interference Management
RQA Reflective QoS Attribute
RQI Reflective QoS Indication
RSN Redundancy Sequence Number
SA NR Standalone New Radio
SBA Service Based Architecture
SBI Service Based Interface
SCP Service Communication Proxy
SD Slice Differentiator
SEAF Security Anchor Functionality
SEPP Security Edge Protection Proxy
SMF Session Management Function
SMSF Short Message Service Function
SN Sequence Number
SN name Serving Network Name.
SNPN Stand-alone Non-Public Network
S-NSSAI Single Network Slice Selection Assistance Information
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TMSI Temporary Mobile Subscriber Identity
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMF UE radio Capability Management Function
UDM Unified Data Management
UDR Unified Data Repository
UDSF Unstructured Data Storage Function
UL Uplink
UL CL Uplink Classifier
UPF User Plane Function
URLLC Ultra Reliable Low Latency Communication
URRP-AMF UE Reachability Request Parameter for AMF
URSP UE Route Selection Policy
VID VLAN Identifier
VLAN Virtual Local Area Network
W-5GAN Wireline 5G Access Network
W-5GBAN Wireline BBF Access Network
W-5GCAN Wireline 5G Cable Access Network
W-AGF Wireline Access Gateway Function

### Definitions

For the purposes of the present document, the terms and definitions given in 3GPP TR 21.905 (NPL1) and the following apply. A term defined in the present document takes precedence over the definition of the same term, if any, in 3GPP TR 21.905 (NPL1).

General

The principle of following embodiments also applicable for the case when a UE initiates initial registration procedure and sends SUCI 2 in the registration request message and MIMT replaces SUCI 2 with SUCI 1 in the Registration Request message.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the embodiments disclosed herein in addition to, or instead of, a system, and all such embodiments are contemplated as within the scope of the present disclosure.

### First Example Embodiment (Solution 1 Detection of Corrupted NAS Message at the NG-RAN)

When a UE initiates an initial NAS procedure, the UE sets a 5G-GUTI to both in AS message (e.g. RRC Setup Request message and RRC Setup Complete message) and initial NAS message (e.g. registration request message or service request message). If the Man-In-The-Middle attacker (MITM) only changes 5G-GUTI in the NAS message and does not change 5G-GUTI in the AS message, a legitimate (R)AN can compare 5G-GUTI in the NAS message and other one in the AS message. For example, the legitimate (R)AN includes a legitimate gNB. If the 5G-GUTI in the NAS message and the 5G-GUTI in the AS message don't match, the legitimate (R)AN determines that the NAS message is corrupted and will discard the NAS message.

Note that an MITM includes a Fake (R)AN and a Fake UE in this solution. For example, the Fake (R)AN includes a Fake gNB.

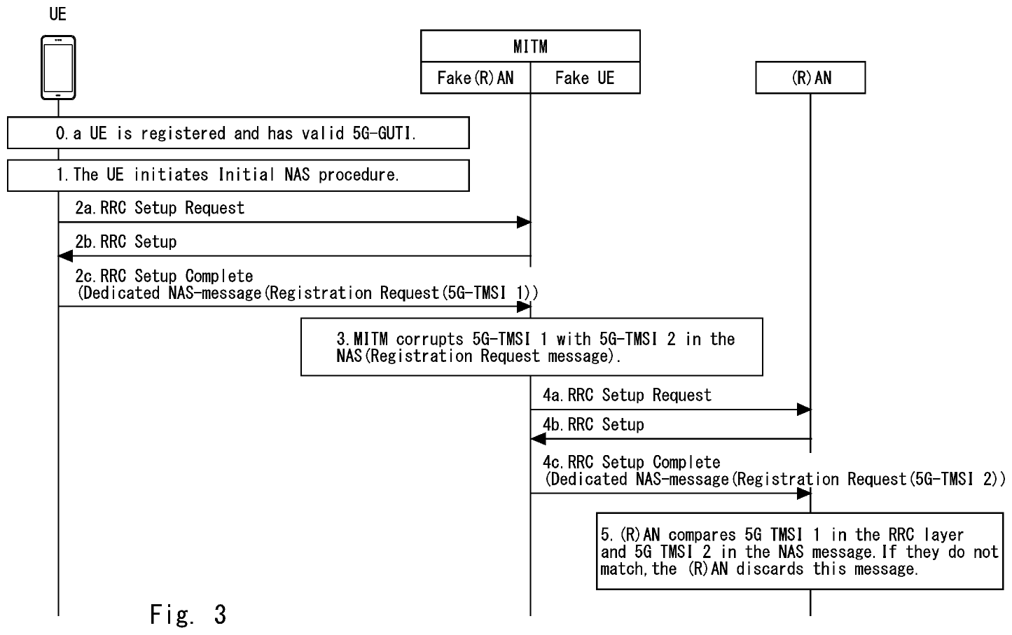

FIG. 3 illustrates procedure for detection and handling of corrupt NAS message at the (R)AN.

The detailed steps of the solution are described below.
0) The UE is registered to a PLMN successfully and has a valid 5G-GUTI (e.g. 5G-GUTI 1 including 5G-TMSI 1).
1) The UE is camping on a cell of Fake (R)AN. For example, the UE is camping on a cell of a Fake gNB in the Fake (R)AN. The UE initiates an initial NAS procedure (e.g. Registration procedure, or service request procedure) in the cell.
2a) The UE sends RRC Setup Request message to the Fake (R)AN (for example, the Fake gNB).
2b) The Fake (R)AN (for example, the Fake gNB) sends RRC Setup message to the UE.
2c) The UE sends RRC Setup Complete message to the Fake (R)AN (for example, the Fake gNB). The RRC Setup Complete message includes the 5G-GUTI (i.e. the 5G-GUTI 1 including 5G-TMSI 1) or 5G-S-TMSI including 5G-TMSI (i.e. 5G-TMSI 1) and a Dedicated NAS-message. An Initial NAS message (for example, a registration request message) in the Dedicated NAS-message also contains (or includes) the 5G-GUTI (i.e. the 5G-GUTI 1 including 5G-TMSI 1).
3) The MITM corrupts the 5G-TMSI component of the 5G-GUTI 1 in the NAS message (for example, the registration request message) with random 5G-TMSI (i.e. the 5G-GUTI 1 is changed to 5G-GUTI 2). For example, the MITM changes 5G-GUTI 1 to 5G-GUTI 2 by corrupting (or changing) 5G-TMSI 1 of the 5G-GUTI 1 to 5G-TMSI 2. The 5G-GUTI 2 includes 5G-TMSI 2. The MITM may change the 5G-TMSI1 to 5G-TMSI other than the 5G-TMSI 1 (that is, the MITM may change the 5G-TMSI 1 to 5G-TMSI which is different from the 5G-TMSI 1).
4a) The Fake UE sends RRC Setup Request message to a legitimate (R)AN (for example, a legitimate gNB) of the PLMN. For example, the legitimate (R)AN includes the legitimate gNB. In addition, for example, the legitimate (R)AN and the legitimate gNB are called as a (R)AN node or a (R)AN apparatus.
4b) The legitimate (R)AN (for example, the legitimate gNB) sends RRC Setup message to the Fake UE.
4c) The Fake UE sends RRC Setup Complete message to the legitimate (R)AN (for example, the legitimate gNB). The RRC Setup Complete message includes the 5G-GUTI (i.e. the 5G-GUTI 1) or 5G-S-TMSI including 5G-TMSI (i.e., 5G-TMSI 1) as the same one in the step 2c and a Dedicated NAS-message. An Initial NAS message (for example, a registration request message) in the Dedicated NAS-message contains (or includes) the 5G-GUTI (i.e. the 5G-GUTI 2 including 5G-TMSI 2) that was corrupted by the MITM in step 3.
5) The legitimate (R)AN (for example, the legitimate gNB) compares the 5G-GUTI 1 or the 5G-S-TMSI including the 5G-TMSI 1 received in the RRC Setup Complete message in step 4c (that is, in the RRC layer) and the 5G-GUTI 2 including the 5G-TMSI 2 in the initial NAS message (for example, the registration request message). If the legitimate (R)AN determines that the 5G-GUTI 1 and the 5G-GUTI 2 are different (that is, the 5G-GUTI 1 does not match (or does not correspond to) the 5G-GUTI 2), the legitimate (R)AN (for example, the legitimate gNB) determines that the initial NAS message is corrupted.

For example, the legitimate (R)AN (for example, the legitimate gNB) compares the 5G-TMSI 1 of the 5G-GUTI 1 or 5G-TMSI 1 of the 5G-S-TMSI in the RRC Setup Complete message and the 5G-TMSI 2 of the 5G-GUTI 2 in the initial NAS message. If the legitimate (R)AN determines that the 5G-TMSI 1 is different from the 5G-TMSI 2 (that is, the 5G-TMSI 1 does not match (or does not correspond to) the 5G-TMSI 2), the legitimate (R)AN determines that the initial NAS message is corrupted.

If the legitimate (R)AN (for example, the legitimate gNB) determines that the initial NAS message is corrupted, the legitimate (R)AN discards the RRC Setup Complete message. The legitimate (R)AN (for example, the legitimate gNB) further releases the RRC connection.

The legitimate (R)AN (for example, the legitimate gNB) may report the detection of the corrupted NAS message to an operation and maintenance system with the RRC Setup Complete message or some key parameters (for example, 5G-GUTI 1, the 5G-S-TMSI, 5G-TMSI 1,5G-GUTI 2, 5G-TMSI 2, Cell identifier and etc.).

### Second Example Embodiment (Solution 2 Detection of Corrupted NAS Message at the AMF)

When a UE initiates an initial NAS procedure, the UE sets a 5G-GUTI to both in AS message (e.g. RRC Setup Request message and RRC Setup Complete message) and initial NAS message (e.g. registration request message or service request message). If the Man-In-The-Middle attacker (MITM) only changes 5G-GUTI in the NAS message and does not change 5G-GUTI in the AS message, a legitimate AMF can compare 5G-GUTI in NAS message and other one in NGAP message. If the 5G-GUTI in the NAS message and the 5G-GUTI in the NGAP message don't match, the AMF determines that the NAS message is corrupted and will discard the NAS message.

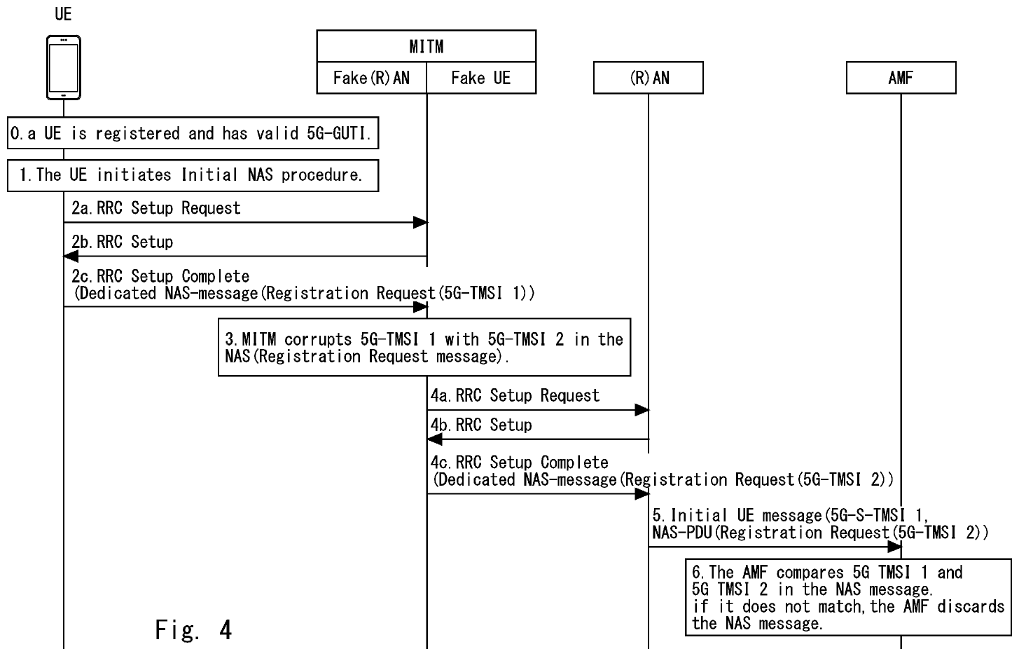

FIG. 4 illustrates procedure for detection and handling of corrupt NAS message at the AMF.

The detailed steps of the solution are described below.
0) The UE is registered to a PLMN successfully and has a valid 5G-GUTI (e.g. 5G-GUTI 1 including 5G-TMSI 1).
1) The UE is camping on a cell of Fake (R)AN. For example, the UE is camping on a cell of a Fake gNB in the Fake (R)AN. The UE initiates an initial NAS procedure (e.g. Registration procedure, or service request procedure) in the cell.
2a) The UE sends RRC Setup Request message to the Fake (R)AN (for example, the Fake gNB).
2b) The Fake (R)AN (for example, the Fake gNB) sends RRC Setup message to the UE.
2c) The UE sends the RRC Setup Complete message to the Fake (R)AN (for example, the Fake gNB). The RRC Setup Complete message includes the 5G-GUTI (i.e. the 5G-GUTI 1 including 5G-TMSI 1) or 5G-S-TMSI 1 including 5G-TMSI (i.e. 5G-TMSI 1) and a Dedicated NAS-message. An Initial NAS message (for example, a registration request message) in the Dedicated NAS-message also contains (or includes) the 5G-GUTI (i.e. the 5G-GUTI 1 including 5G-TMSI 1).
3) The MITM corrupts the 5G-TMSI component of the 5G-GUTI 1 in the NAS message (for example, the registration request message) with random 5G-TMSI (i.e. the 5G-GUTI 1 is changed to 5G-GUTI 2). For example, the MITM changes 5G-GUTI 1 to 5G-GUTI 2 by corrupting (or changing) 5G-TMSI 1 of the 5G-GUTI 1 to 5G-TMSI 2. The 5G-GUTI 2 includes 5G-TMSI 2. The MITM may change the 5G-TMSI1 to 5G-TMSI other than the 5G-TMSI 1 (that is, the MITM may change the 5G-TMSI 1 to 5G-TMSI which is different from the 5G-TMSI 1).
4a) The Fake UE sends RRC Setup Request message to a legitimate (R)AN (for example, a legitimate gNB) of the PLMN. For example, the legitimate (R)AN includes the legitimate gNB.
4b) The legitimate (R)AN (for example, the legitimate gNB) sends RRC Setup message to the Fake UE.
4c) The Fake UE sends the RRC Setup Complete message to the legitimate (R)AN (for example, the legitimate gNB). The RRC Setup Complete message includes the 5G-GUTI (i.e. the 5G-GUTI 1) or 5G-S-TMSI 1 including 5G-TMSI (i.e., 5G-TMSI 1) as the same one in the step 2c and a Dedicated NAS-message. An Initial NAS message (for example, a registration request message) in the Dedicated NAS-message contains (or includes) the 5G-GUTI (i.e. the 5G-GUTI 2 including 5G-TMSI 2) that was corrupted by the MITM in step 3.
5) The legitimate (R)AN (for example, the legitimate gNB) sends the Initial UE message to the AMF. The Initial UE message contains (or includes) the 5G-GUTI 1 or the 5G-S-TMSI 1 that is received by the RRC Setup Complete message in step 4c. The Initial UE message also includes a NAS-PDU. The NAS-PDU includes the Initial NAS message (for example, the registration request message) as mentioned in step 4c. That is, The NAS-PDU includes the 5G-GUTI (i.e. the 5G-GUTI 2 including 5G-TMSI 2) that was corrupted by the MITM in step 3. For example, the AMF is called as a core network node or a core network apparatus.
6) The AMF compares the 5G-GUTI 1 or the 5G-S-TMSI 1 including the 5G-TMSI 1 received in the Initial UE message and the 5G-GUTI 2 including the 5G-TMSI 2 in the initial NAS message (for example, the registration request message). If the AMF determines that the 5G-GUTI 1 and the 5G-GUTI 2 are different (that is, the 5G-GUTI 1 does not match (or does not correspond to) the 5G-GUTI 2), the AMF determines that the initial NAS message is corrupted.

For example, the AMF compares the 5G-TMSI 1 of the 5G-GUTI 1 or 5G-TMSI 1 of the 5G-S-TMSI 1 in the Initial UE message and the 5G-TMSI 2 of the 5G-GUTI 2 in the initial NAS message. If the AMF determines that the 5G-TMSI 1 is different from the 5G-TMSI 2 (that is, the 5G-TMSI 1 does not match (or does not correspond to) the 5G-TMSI 2), the AMF determines that the initial NAS message is corrupted.

If the AMF determines that the initial NAS message is corrupted, the AMF discards the NAS message (for example, the registration request message).

The AMF may report the detection of the corrupted NAS message to an operation and maintenance system with the Initial UE message or some key parameters (for example, 5G-GUTI 1, 5G-S-TMSI 1, 5G-TMSI 1, 5G-GUTI 2, 5G-TMSI 2, Cell identifier and etc.).

The above processes performed by the AMF may be performed by the SEAF.

Variant 1 of the Solution 2

In step 6 of solution 2, when the AMF determines that the NAS message is corrupted the AMF sends, to the legitimate (R)AN, an NGAP message containing (or including) the 5G-TMSI 2 of the NAS message (for example, the registration request message) that is received in the step 5 to request the legitimate (R)AN for a screening process for an RRC Setup related to the 5G-TMSI 2. The NGAP message may be a new NGAP message or existing NGAP message.

Upon receiving the NGAP message the legitimate (R)AN discards any RRC Setup Complete message containing (or including) the 5G-TMSI 2 in RRC signaling or the NAS message containing (or including) the 5G-TMSI 2 as it is the corrupted or falsely generated 5G-TMSI.

The above processes performed by the AMF may be performed by the SEAF.

### Third Example Embodiment (Solution 3 Determining Fake UE During Identity Request Procedure)

Whenever the MITM corrupts a 5G-GUTI in the registration request messages, the AMF will not find the UE context related to the corrupted 5G-GUTI in the AMF and will send the Identity Request message to the UE to fetch a SUCI of the UE. If the AMF memorizes a SUCI received in the identity response message from the UE or a combination of 5G-GUTI received in the registration request message and a SUCI received in the identity response message from the UE due to corrupted 5G-GUTI for pre-defined period in the past, the AMF can find a Linkability attack attempt if the received SUCI matches with a one being memorized in the AMF. If the AMF finds a possible Linkability attack attempt, the AMF aborts the Initial NAS procedure.

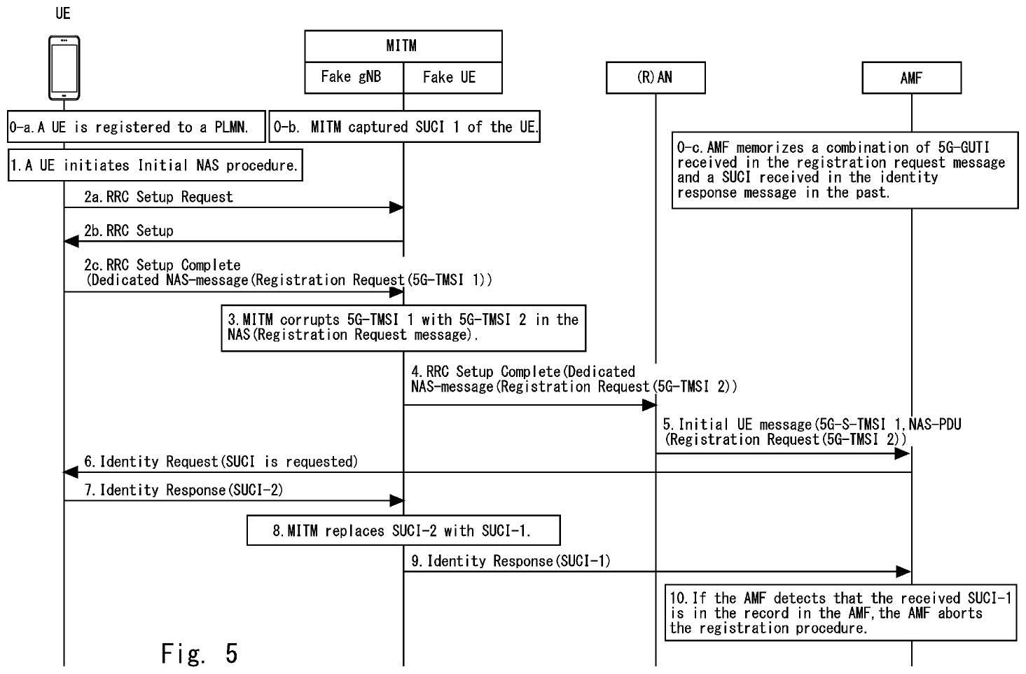

FIG. 5 illustrates procedure for detection and handling of corrupt NAS message at the AMF.

The detailed steps of the procedure are given below.
0-a) A UE is registered in a PLMN successfully and has a valid 5G-GUTI 1 (e.g. 5G-GUTI 1 including 5G-TMSI 1). The UE has sent SUCI 1 previously in registration request message. For example, the UE has sent SUCI 1 in the registration request message before the UE has the valid 5G-GUTI.
0-b) The MITM has captured and stored the SUCI 1 of the UE from the registration request message in the past.
0-c) The AMF has stored the SUCI 1 that has received in the identity response message in the past.

In addition, the AMF may store SUCIs other than the SUCI 1. Further, the AMF may store combination of 5G-GUTI that has been received in the registration request message and a SUCI that has been received in an identity response message that is triggered by the registration request message. The AMF may store combination of 5G-TMSI included in the 5G-GUTI and the SUCI. For example, the AMF may store combination of 5G-GUTI and the SUCI 1 or combination of 5G-TMSI of the 5G-GUTI and the SUCI 1.
1) The UE is camping on a cell of Fake (R)AN. For example, the UE is camping on a cell of a Fake gNB in the Fake (R)AN. The UE initiates an initial NAS procedure (e.g. Registration procedure, or service request procedure) in the cell.
2a) The UE sends RRC Setup Request message to the Fake (R)AN (for example, the Fake gNB).
2b) The Fake (R)AN (for example, the Fake gNB) sends RRC Setup message to the UE.
2c) The UE sends the RRC Setup Complete message to the Fake (R)AN (for example, the Fake gNB). The RRC Setup Complete message includes the 5G-GUTI (i.e. the 5G-GUTI 1 including 5G-TMSI 1) or 5G-S-TMSI 1 including 5G-TMSI (i.e. 5G-TMSI 1) and a Dedicated NAS-message. An Initial NAS message (for example, a registration request message) in the Dedicated NAS-message also contains (or includes) the 5G-GUTI (i.e. the 5G-GUTI 1 including 5G-TMSI 1).
3) The MITM corrupts the 5G-TMSI component of the 5G-GUTI 1 in the NAS message (for example, the registration request message) with random 5G-TMSI (i.e. the 5G-GUTI 1 is changed to 5G-GUTI 2). For example, the MITM changes 5G-GUTI 1 to 5G-GUTI 2 by corrupting (or changing) 5G-TMSI 1 of the 5G-GUTI 1 to 5G-TMSI 2. The 5G-GUTI 2 includes 5G-TMSI 2. The MITM may change the 5G-TMSI1 to 5G-TMSI other than the 5G-TMSI 1 (that is, the MITM may change the 5G-TMSI 1 to 5G-TMSI which is different from the 5G-TMSI 1).
4) The Fake UE sends RRC Setup Request message to a legitimate (R)AN (for example, a legitimate gNB) of the PLMN. For example, the legitimate (R)AN includes the legitimate gNB. The legitimate (R)AN (for example, the legitimate gNB) sends RRC Setup message to the Fake UE. The Fake UE sends the RRC Setup Complete message to the legitimate (R)AN (for example, the legitimate gNB) after a successful RRC connection setup. The RRC Setup Complete message includes the 5G-GUTI (i.e. the 5G-GUTI 1) or 5G-S-TMSI 1 including 5G-TMSI (i.e., 5G-TMSI 1) as the same one in the step 2c and a Dedicated NAS-message. An Initial NAS message (for example, a registration request message) in the Dedicated NAS-message contains (or includes) the 5G-GUTI (i.e. the 5G-GUTI 2 including 5G-TMSI 2) that was corrupted by the MITM in step 3.
5) The legitimate (R)AN (for example, the legitimate gNB) sends the Initial UE message to the AMF during the NAS procedure. The Initial UE message contains (or includes) the 5G-GUTI 1 or the 5G-S-TMSI 1 that is received by the RRC Setup Complete message in step 4. The Initial UE message also includes a NAS-PDU. The NAS-PDU includes the Initial NAS message (for example, the registration request message) as mentioned in step 4. That is, The NAS-PDU includes the 5G-GUTI (i.e. the 5G-GUTI 2 including 5G-TMSI 2) that was corrupted by the MITM in step 3.
6) When the AMF receives the initial UE message including the 5G-TMSI 2, the AMF does not find the UE context of the UE related to the 5G-TMSI 2 of the 5G-GUTI 2. The AMF initiates Identification procedure to get a SUCI of the UE by sending, to the UE, Identity Request message with identity type set to a SUCI.
7) The UE computes the SUCI (i.e. SUCI 2) and sends the Identity response message including the SUCI 2 to the Fake (R)AN (for example, the Fake gNB).
8) The Fake (R)AN (for example, the Fake gNB) replaces the SUCI 2 with SUCI 1 in the Identity response message based on stored SUCI 1 in the MITM.
9) The Fake (R)AN (for example, the Fake gNB) sends the Identity Request message containing (or including) SUCI 1 to the AMF.
10) When the AMF receives the SUCI 1, the AMF compares the SUCI 1 with all SUCIs stored in the AMF. If the AMF finds a match of the SUCI 1 (or if the AMF determines that the SUCI 1 corresponds to one of the SUCIs stored in the AMF), the AMF determines that the SUCI 1 is no longer valid. The AMF discards the registration request message and aborts the initial NAS procedure (for example the registration procedure). The AMF determines that there is an MITM changing SUCI in the Identity response message.

The AMF may report the detection of the corrupted NAS message to an operation and maintenance system with the Initial UE message or some key parameters (for example, 5G-GUTI 1, 5G-S-TMSI 1, 5G-TMSI 1, 5G-GUTI 2, 5G-TMSI 2, SUCI 1, Cell identifier and etc.).

In addition, in step 10, the AMF may determine whether combination of the 5G-GUTI 2 or 5G-TMSI 2 received in step 5 and the SUCI 1 received in step 9 is included the combination stored in the AMF. If the AMF finds the combination of the 5G-GUTI 2 or 5G-TMSI 2 received in step 5 and the SUCI 1 received in step 9 in the stored combination (or if the AMF determines that the combination of the 5G-GUTI 2 or 5G-TMSI 2 received in step 5 and the SUCI 1 received in step 9 corresponds to the stored combination), the AMF determines that the SUCI 1 is no longer valid. The AMF discards the registration request message and aborts the initial NAS procedure (for example the registration procedure). The AMF determines that there is an MITM changing 5G-GUTI in the NAS message and SUCI in the Identity response message.

The above processes performed by the AMF may be performed by the SEAF.

Variant 1 of Solution 3 In one example, the NWDAF may subscribe to an MITM detection service provided by the AMF. When the AMF receives a SUCI in a registration request message or identity response message, the AMF sends the received SUCI, an associated 5G-GUTI, received E-UTRAN Cell Identity (ECI), received E-UTRAN Cell Global Identification (ECGI), received NR Cell Identity (NCI), received NR Cell Global Identity (NCGI), time information when the AMF receives the registration request message or the identity response message and some important parameters in the registration request message or identity response message to the NWDAF using a first message which is either an existing message between a NF and NWDAF or a new message. The AMF may wait for a response message from the NWDAF.

If the received SUCI has no associated T3519 running in the NWDAF for a pre-determined period (e.g. 24 hours), the NWDAF starts T3519 for the received SUCI. If the received SUCI has no associated T3510 running in the NWDAF, the NWDAF starts T3510 for the received SUCI. The NWDAF starts T3511 if T3510 expires for the received SUCI.

If the received SUCI has the associated T3519 running or the associated T3519 has been expired lately within a pre-determined period (e.g. 24 hours), or the received SUCI has the associated T3510 running or the associated T3511 running in the NWDAF, following processes apply to the NWDAF.
If the NWDAF detects that the AMF sends the same SUCI after T3519 timer value (e.g. 60 seconds) or the AMF sends the same SUCI within 25 seconds (sum of T3510 timer value and T3511 timer value), then the NWDAF sends a second message which is either an existing message between an NWDAF and a NF or a new message to the AMF to reject the registration procedure. Upon receiving the second message the AMF rejects the registration procedure with cause value such as illegal UE or fake base station.
If the NWDAF detects that the AMF sends the same SUCI within T3519 timer value, the NWDAF sends a third message which is an existing message between the NF and NWDAF or a new message indicating to proceed for the registration procedure. The AMF upon receiving the third message proceeds with the registration procedure.

In one example, if the NWDAF determines that same SUCI is sent by a different AMF then the NWDAF determines that a Man in the Middle is working in the network. The NWDAF in this case, sends request to the AMF sending the SUCI to reject the registration procedure as described above. The AMF will follow the procedure as defined above.

Once the NWDAF determines that the MITM is in the network, the NWDAF informs it to the Operation and Maintenance (OAM) in order for the OAM to take some security actions.

The above processes performed by the AMF may be performed by the SEAF.

Variant 2 of Solution 3

In one example, the NWDAF may subscribe to an MITM detection service provided by the AMF.

When the AMF receives a same SUCI after T3519 in a registration request message or identity response message, the AMF sends the received SUCI, an associated 5G-GUTI, received E-UTRAN Cell Identity (ECI), received E-UTRAN Cell Global Identification (ECGI), received NR Cell Identity (NCI), received NR Cell Global Identity (NCGI), time information when the AMF receives the registration request message or the identity response message and some important parameters in the registration request message or identity response message to the NWDAF using a first message which is either an existing message between a NF and NWDAF or a new message. The AMF may wait for the response message from the NWDAF.

If the received SUCI has no associated T3519 running in the NWDAF for a pre-determined period (e.g. 24 hours), the NWDAF starts T3519 for the received SUCI.

If the received SUCI has the associated T3519 running or the associated T3519 has been expired lately within a pre-determined period (e.g. 24 hours), following processes apply to the NWDAF.
If the NWDAF detects that the SUCI shall not be sent by the UE after T3519 timer (for example, if the NWDAF detects that the T3519 expires) then the NWDAF sends a second message which is either an existing message between an NWDAF and a NF or a new message to the AMF to reject the registration procedure. Upon receiving the second message the AMF rejects the registration procedure with cause value such as illegal UE or fake base station.
If the NWDAF detects that the AMF sends the same SUCI within T3519 timer value, the NWDAF sends a third message which is an existing message between the NF and NWDAF or a new message indicating to proceed for the registration procedure. The AMF upon receiving the third message proceeds with the registration procedure.

In one example, if the NWDAF determines that same SUCI is sent by a different AMF then the NWDAF determines that a Man in the Middle is working in the network. The NWDAF in this case, sends request to the AMF sending the SUCI to reject the registration procedure as described above. The AMF will follow the procedure as defined above.

Once the NWDAF determines that the MITM is in the network, the NWDAF informs it to the Operation and Maintenance (OAM) in order for the OAM to take some security actions.

The above processes performed by the AMF may be performed by the SEAF.

### Fourth Embodiment (Solution 4 UDM Discards SUCI after 60 Seconds)

When a UDM receives a SUCI in the Nudm_UEAuthentication_Get Request for the first time the UDM starts a timer T3519 (60 seconds). When the UDM receives the same SUCI in the Nudm_UEAuthentication_Get Request while timer T3519 is running, then the UDM initiates the authentication procedure, otherwise (that is, the UDM receives the same SUCI in the Nudm_UEAuthentication_Get Request in a case where timer T3519 is not running or expired) the UDM determines that the UE is Fake UE and rejects the Nudm_UEAuthentication_Get Request. The UDM maintains n number of latest SUCIs per SUPI after the expiry of the timer T3519 for each SUCI (n is a positive integer). The UDM rejects the Nudm_UEAuthentication_Get Request when the fake UE stores one of the stored SUCIs.

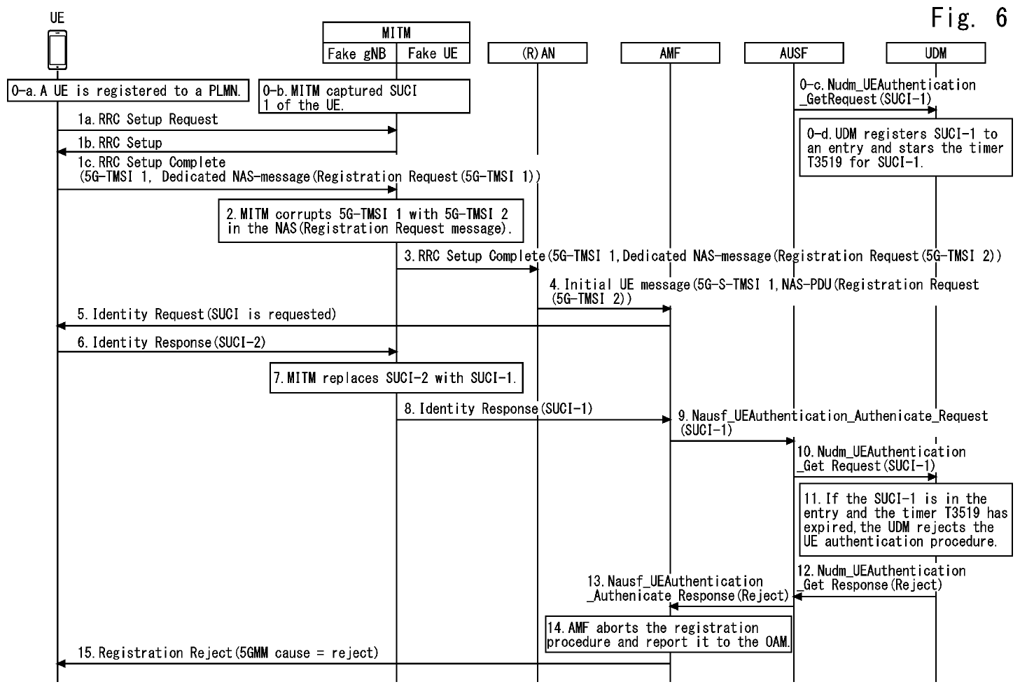

FIG. 6 illustrates procedure for detection and handling of corrupt NAS message at the UDM.

The detailed steps of the procedure are given below.
0-a) A UE is registered in a PLMN successfully and has a valid 5G-GUTI 1 (e.g. 5G-GUTI 1 including 5G-TMSI 1). The UE has sent SUCI 1 previously in registration request message. For example, the UE has sent SUCI 1 in the registration request message before the UE has the valid 5G-GUTI.
0-b) The MITM has captured and stored the SUCI 1 of the UE from the registration request message in the past.
0-c) The UDM receives SUCI 1 for the first time in the Nudm_UEAuthentication_GetRequest during an authentication procedure. For example, the UDM is called as a core network node or a core network apparatus.
0-d) The UDM stores the SUCI 1 and starts a timer T3519 for the SUCI 1 (for example, a value of T3519 is 60 seconds). In addition, the UDM may start the timer T3519 in a case where the UDM receives the SUCI 1.

In addition, the UDM may deconceal the SUCI 1 to SUPI when the UDM receives the SUCI 1. Then the UDM may store combination of SUCI 1 and the SUPI. Further, the UDM may deconceal SUCI other than the SUCI 1 to SUPI, and the UDM may store combination of the SUCI and the SUPI. The UDM may store a plurality of combinations of SUCI and SUPI (for example, combination of SUCI 1 and SUPI 1, a combination of SUCI 2 and SUPI 2 and so on). The UDM may keep (or maintain) received SUCIs (e.g. SUCI 1) per SUPI for pre-defined period (e.g. 24 hours).
1a) The UE is camping on a cell of a Fake (R)AN. For example, the UE is camping on a cell of a Fake gNB in the Fake (R)AN. The UE initiates an initial NAS procedure (e.g. Registration procedure, or service request procedure) in the cell. The UE sends RRC Setup Request message to the Fake (R)AN (for example, the Fake gNB).
1b) The Fake (R)AN (for example, the Fake gNB) sends RRC Setup message to the UE.
1c) The UE sends the RRC Setup Complete message to the Fake (R)AN (for example, the Fake gNB). The RRC Setup Complete message includes the 5G-GUTI (i.e. the 5G-GUTI 1 including 5G-TMSI 1) or 5G-S-TMSI 1 including 5G-TMSI (i.e. 5G-TMSI 1) and a Dedicated NAS-message. An Initial NAS message (for example, a registration request message) in the Dedicated NAS-message also contains (or includes) the 5G-GUTI (i.e. the 5G-GUTI 1 including 5G-TMSI 1).
2) The MITM corrupts the 5G-TMSI component of the 5G-GUTI 1 in the NAS message (for example, the registration request message) with random 5G-TMSI (i.e. the 5G-GUTI 1 is changed to 5G-GUTI 2). For example, the MITM changes 5G-GUTI 1 to 5G-GUTI 2 by corrupting (or changing) 5G-TMSI 1 of the 5G-GUTI 1 to 5G-TMSI 2. The 5G-GUTI 2 includes 5G-TMSI 2. The MITM may change the 5G-TMSI1 to 5G-TMSI other than the 5G-TMSI 1 (that is, the MITM may change the 5G-TMSI 1 to 5G-TMSI which is different from the 5G-TMSI 1).
3) The Fake UE sends RRC Setup Request message to a legitimate (R)AN (for example, a legitimate gNB) of the PLMN. For example, the legitimate (R)AN includes the legitimate gNB. The legitimate (R)AN (for example, the legitimate gNB) sends RRC Setup message to the Fake UE. The Fake UE sends the RRC Setup Complete message to the legitimate (R)AN (for example, the legitimate gNB) after a successful RRC connection setup. The RRC Setup Complete message includes the 5G-GUTI (i.e. the 5G-GUTI 1) or 5G-S-TMSI 1 including 5G-TMSI (i.e., 5G-TMSI 1) as the same one in the step 1c and a Dedicated NAS-message. An Initial NAS message (for example, a registration request message) in the Dedicated NAS-message contains (or includes) the 5G-GUTI (i.e. the 5G-GUTI 2 including 5G-TMSI 2) that was corrupted by the MITM in step 2.
4) The legitimate (R)AN (for example, the legitimate gNB) sends the Initial UE message to the AMF during the NAS procedure. The Initial UE message contains (or includes) the 5G-GUTI 1 or the 5G-S-TMSI 1 that is received by the RRC Setup Complete message in step 3. The Initial UE message also includes a NAS-PDU. The NAS-PDU includes the Initial NAS message (for example, the registration request message) as mentioned in step 3. That is, The NAS-PDU includes the 5G-GUTI (i.e. the 5G-GUTI 2 including 5G-TMSI 2) that was corrupted by the MITM in step 2.
5) When the AMF receives the initial UE message including the 5G-TMSI 2, the AMF does not find the UE context of the UE related to the 5G-TMSI 2 of the 5G-GUTI 2. The AMF initiates Identification procedure to get a SUCI of the UE by sending, to the UE, Identity Request message with identity type set to a SUCI.
6) The UE computes the SUCI (i.e. SUCI 2) and sends the Identity response message including the SUCI 2 to the Fake (R)AN (for example, the Fake gNB).
7) The Fake (R)AN (for example, the Fake gNB) replaces the SUCI 2 with SUCI 1 in the Identity response message based on stored SUCI 1 in the MITM.
8) The Fake (R)AN (for example, the Fake gNB) sends the Identity Request message containing (or including) SUCI 1 to the AMF.
9) On receiving the SUCI 1, the AMF sends a Nausf_UEAuthentication_Authenticate Request message including SUCI 1 to the AUSF. The Nausf_UEAuthentication_Authenticate Request message may include an associated 5G-GUTI to the SUCI, E-UTRAN Cell Identity (ECI), E-UTRAN Cell Global Identification (ECGI), NR Cell Identity (NCI), NR Cell Global Identity (NCGI), time information when the AMF receives the registration request message or the identity response message.
10) On receiving the Nausf_UEAuthentication_Authenticate Request message including SUCI 1, the AUSF sends Nudm_UEAuthentication_Get Request message including SUCI 1 to the UDM. The Nudm_UEAuthentication_Get Request message may include an associated 5G-GUTI to the SUCI, E-UTRAN Cell Identity (ECI), E-UTRAN Cell Global Identification (ECGI), NR Cell Identity (NCI), NR Cell Global Identity (NCGI), time information when the AMF receives the registration request message or the identity response message.
11) When the UDM receives the Nudm_UEAuthentication_Get Request message including SUCI 1, the UDM deconceals SUCI 1 to SUPI. The UDM determines whether SUCI 1 for the SUPI is stored in the UDM and the timer T3519 is running or not. For example, if the UDM determines that the SUCI 1 matches one of the stored SUCIs as mentioned in step 0-d (or if the UDM determines that the SUCI 1 corresponds to one of the stored SUCIs as mentioned in step 0-d), the UDM considers that the SUCI 1 for the SUPI is stored in the UDM. Otherwise the UDM considers that the SUCI 1 for the SUPI is not stored in the UDM.

For example, the UDM determines whether combination of SUCI 1 and the SUPI obtained by deconcealing the SUCI 1 matches one of the stored combinations as mentioned in step 0-d. If the UDM determines that the combination matches one of the stored combinations (or if the UDM determines that the combination corresponds to one of the stored combinations), the UDM considers that the SUCI 1 for the SUPI is stored in the UDM. Otherwise the UDM considers that the SUCI 1 for the SUPI is not stored in the UDM.

The UDM will take one of the following action:
i) if the SUCI 1 for the SUPI is not stored then the UDM stores the SUCI 1 for the SUPI and starts timer T3519 (for example, if combination of the SUCI 1 and SUPI obtained by deconcealing the SUCI 1 is not stored in the UDM, the UDM stores the combination and starts timer T3519 for the SUCI 1). The UDM initiates authentication procedure towards the UE by sending a Nudm_UEAuthentication_Get Response message.
ii) if the SUCI 1 for the SUPI is stored and the timer T3519 is running for the SUCI 1, then the UDM initiates authentication procedure to the UE.
iii) if the SUCI 1 for the SUPI is stored for the SUPI and the timer T3519 has expired (or T3519 is not running), then the UDM rejects the Nudm_UEAuthentication_Get Request message and sends a Nudm_UEAuthentication_Get Response message with reject cause (e.g. illegal UE). That is, the UDM rejects authentication procedure. The reject cause may be included in the Nudm_UEAuthentication_Get Response message. The UDM may determine that the MITM is in the network. Once the NWDAF or the UDM determines that the MITM is in the network, the NWDAF or the UDM informs it to the Operation and Maintenance (OAM) in order for the OAM to take some security actions.

In one example, the UDM sends reject cause set to illegal UE if the UDM receives SUCI 1 first time after expiration of the timer T3519.

In another example, when the UDM receives SUCI 1 multiple times after the expiration of timer T3519 then the UDM can determine that there is a MITM and the MITM corrupts the SUCI. In this case the UDM performs authentication procedure and after successful authentication procedure, the UDM sends a new message containing reject cause set to illegal UE to the AUSF. Then the AUSF sends, to the AMF, the message containing (or including) the reject cause. The AMF establishes the security context with UE using the partial security context created during the latest authentication procedure by initiating security mode command procedure. After the security context is established the AMF sends, to the UE, registration reject message containing (or including) reject cause which is integrity protected. On receiving the registration reject message containing the reject cause, the UE shall bar the current cell i.e. the UE shall not consider the current cell for camping.
12) The UDM sends the Nudm_UEAuthentication_Get Response message with reject cause (e.g. illegal UE) to the AUSF. The reject cause may be included in the Nudm_UEAuthentication_Get Response message.
13) The AUSF sends Nausf_UEAuthentication_Authenticate Response message containing (or including) reject cause (e.g. illegal UE) to the AMF.
14) On receiving Nausf_UEAuthentication_Authenticate Response message containing (or including) reject cause (e.g. illegal UE), the AMF aborts the registration procedure and sends, to the UE, a registration reject message containing (or including) 5GS Mobility Management (SGMM) cause set to reject cause (e.g. illegal UE). The AMF may report the detection of the corrupted NAS message to an operation and maintenance system with the Initial UE message or some key parameters (for example, 5G-GUTI 1, 5G-S-TMSI 1, 5G-TMSI 1, 5G-GUTI 2, 5G-TMSI 2, SUCI 1, Cell identifier and etc.).
15) On receiving the registration reject message containing (or including) the reject cause (e.g. illegal UE), the UE aborts the registration procedure and if the SGMM cause is set to illegal UE then the UE enters into limited service state and shall be considered the USIM as invalid until the UE is power cycle. In addition, for example, on receiving the registration reject message containing(or including) the reject cause, the UE shall bar the current cell i.e. the UE shall not consider the current cell for camping.

Variant 1 of Solution 4

In one example, the NWDAF may subscribe to an MITM detection service provided by the UDM. When a UDM receives a SUCI in a Nudm_UEAuthentication_GetRequest message, the UDM sends the received SUCI, an associated 5G-GUTI, received E-UTRAN Cell Identity (ECI), received E-UTRAN Cell Global Identification (ECGI), received NR Cell Identity (NCI), received NR Cell Global Identity (NCGI), time information when the AMF receives the registration request message or the identity response message and some important parameters in the Nudm_UEAuthentication_GetRequest message to a NWDAF using a first message which is either an existing message between a NF and NWDAF or a new message.

Note that the Nausf_UEAuthentication_Authenticate Request message and the Nudm_UEAuthentication_GetRequest message may include a SUCI and an associated 5G-GUTI, E-UTRAN Cell Identity (ECI), E-UTRAN Cell Global Identification (ECGI), NR Cell Identity (NCI), NR Cell Global Identity (NCGI), time information when the AMF receives the registration request message or the identity response message. The UDM may wait for the response message from the NWDAF.

If the received SUCI has no associated T3519 running in the NWDAF for a pre-determined period (e.g. 24 hours), the NWDAF starts T3519 for the received SUCI. If the received SUCI has no associated T3510 running in the NWDAF, the NWDAF starts T3510 for the received SUCI. The NWDAF starts T3511 if T3510 expires for the received SUCI.

If the received SUCI has the associated T3519 running or the associated T3519 has been expired lately within a pre-determined period (e.g. 24 hours), or the received SUCI has the associated T3510 running or the associated T3511 running in the NWDAF, following processes apply to the NWDAF.
If the NWDAF detects that the UDM sends the same SUCI after T3519 timer value (e.g. 60 seconds) or the UDM sends the same SUCI within 25 seconds (sum of T3510 timer value and T3511 timer value), then the NWDAF sends a second message which is either an existing message between an NWDAF and a NF or a new message to the UDM to reject the registration procedure. Upon receiving the second message the UDM rejects the registration procedure with cause value such as illegal UE or fake base station. The NWDAF determines that the MITM is in the network.
If the NWDAF detects that the UDM sends the same SUCI within T3519 timer value, the NWDAF sends a third message which is an existing message between the NF and NWDAF or a new message indicating to proceed for the registration procedure. The UDM upon receiving the third message proceeds with the registration procedure.

Variant 2 of Solution 4

In one example, the NWDAF may subscribe to an MITM detection service provided by the UDM.

When the UDM receives a same SUCI after T3519 in a Nudm_UEAuthentication_GetRequest message, the UDM sends the received SUCI, an associated 5G-GUTI, received E-UTRAN Cell Identity (ECI), received E-UTRAN Cell Global Identification (ECGI), received NR Cell Identity (NCI), received NR Cell Global Identity (NCGI), time information when the AMF receives the registration request message or the identity response message and some important parameters in the Nudm_UEAuthentication_GetRequest message to a NWDAF using a first message which is either an existing message between a NF and NWDAF or a new message.

Note that the Nausf_UEAuthentication_Authenticate Request message and the Nudm_UEAuthentication_GetRequest message may include a SUCI and an associated 5G-GUTI, E-UTRAN Cell Identity (ECI), E-UTRAN Cell Global Identification (ECGI), NR Cell Identity (NCI), NR Cell Global Identity (NCGI), time information when the AMF receives the registration request message or the identity response message. The UDM may wait for the response message from the NWDAF.

If the received SUCI has no associated T3519 running in the NWDAF for a pre-determined period (e.g. 24 hours), the NWDAF starts T3519 for the received SUCI.

If the received SUCI has the associated T3519 running or the associated T3519 has been expired lately within a pre-determined period (e.g. 24 hours), following processes apply to the NWDAF.
If the NWDAF detects that the SUCI shall not be sent by the UE after T3519 timer (for example, the NWDAF detects that the T3519 expires) then the NWDAF sends a second message which is either an existing message between an NWDAF and a NF or a new message to the UDM to reject the registration procedure. Upon receiving the second message the UDM rejects the registration procedure with cause value such as illegal UE or fake base station. The NWDAF determines that the MITM is in the network.
If the NWDAF detects that the UDM sends the same SUCI within T3519 timer value, the NWDAF sends a third message which is an existing message between the NF and NWDAF or a new message indicating to proceed for the registration procedure. The UDM upon receiving the third message proceeds with the registration procedure.

Once the NWDAF determines that the MITM is in the network, the NWDAF informs it to the Operation and Maintenance (OAM) in order for the OAM to take some security actions.

User Equipment (UE)

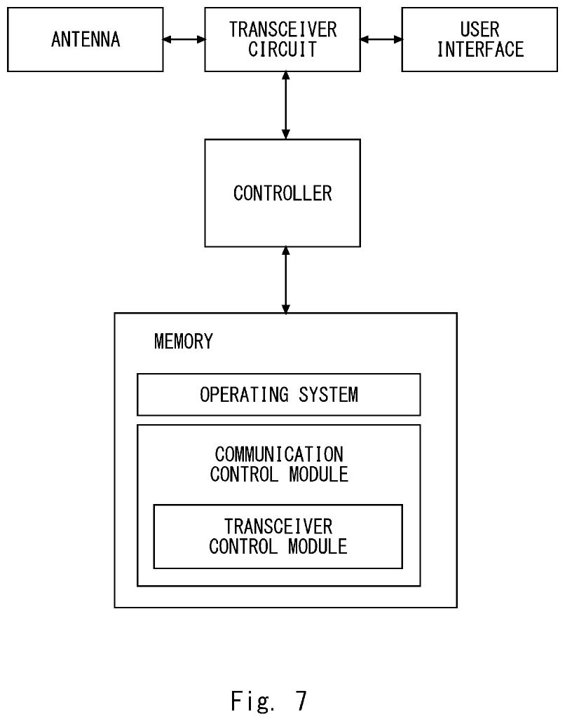

FIG. 7 is a block diagram illustrating the main components of the UE. As shown, the UE includes a transceiver circuit which is operable to transmit signals to and to receive signals from the connected node(s) via one or more antenna. Although not necessarily shown in FIG. 7, the UE will of course have all the usual functionality of a conventional mobile device (such as a user interface) and this may be provided by any one or any combination of hardware, software and firmware, as appropriate. Software may be pre-installed in the memory and/or may be downloaded via the telecommunication network or from a removable data storage device (RMD), for example.

A controller controls the operation of the UE in accordance with software stored in a memory. The software includes, among other things, an operating system and a communications control module having at least a transceiver control module. The communications control module (using its transceiver control sub-module) is responsible for handling (generating/sending/receiving) signalling and uplink/downlink data packets between the UE and other nodes, such as the base station/(R)AN node, the MME, the AMF (and other core network nodes). Such signalling may include, for example, appropriately formatted signalling messages relating to connection establishment and maintenance (e.g. RRC connection establishment and other RRC messages), periodic location update related messages (e.g. tracking area update, paging area updates, location area update) etc. Such signalling may also include, for example, broadcast information (e.g. Master Information and System information) in a receiving case.

(R)AN Node

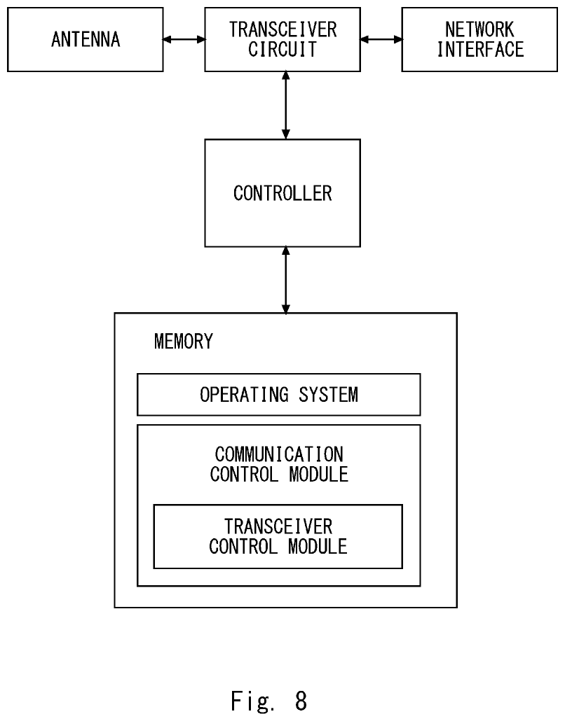

FIG. 8 is a block diagram illustrating the main components of an exemplary (R)AN node, for example a base station (‘eNB’ in LTE, ‘gNB’ in 5G). As shown, the (R)AN node includes a transceiver circuit which is operable to transmit signals to and to receive signals from connected UE(s) via one or more antenna and to transmit signals to and to receive signals from other network nodes (either directly or indirectly) via a network interface. A controller controls the operation of the (R)AN node in accordance with software stored in a memory. Software may be pre-installed in the memory and/or may be downloaded via the telecommunication network or from a removable data storage device (RMD), for example. The software includes, among other things, an operating system and a communications control module having at least a transceiver control module.

The communications control module (using its transceiver control sub-module) is responsible for handling (generating/sending/receiving) signalling between the (R)AN node and other nodes, such as the UE, the MME, the AMF(e.g. directly or indirectly). The signalling may include, for example, appropriately formatted signalling messages relating to a radio connection and location procedures (for a particular UE), and in particular, relating to connection establishment and maintenance (e.g. RRC connection establishment and other RRC messages), periodic location update related messages (e.g. tracking area update, paging area updates, location area update), S1 AP messages and NG AP messages (i.e. messages by N2 reference point), etc. Such signalling may also include, for example, broadcast information (e.g. Master Information and System information) in a sending case.

The controller is also configured (by software or hardware) to handle related tasks such as, when implemented, UE mobility estimate and/or moving trajectory estimation.

AMF

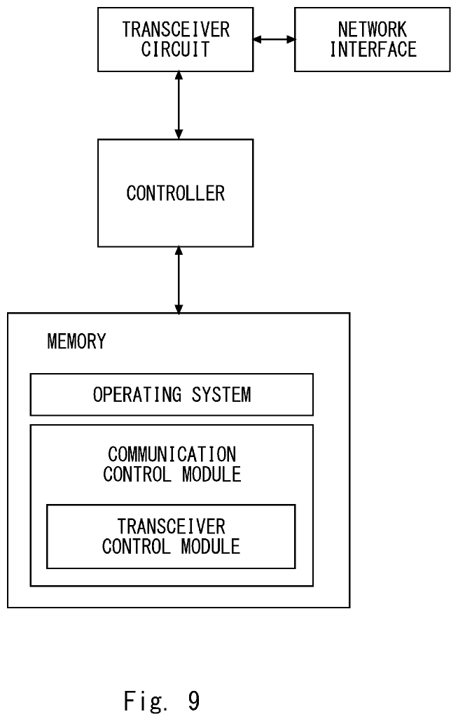

FIG. 9 is a block diagram illustrating the main components of the AMF. The AMF is included in the 5GC. As shown, the AMF includes a transceiver circuit which is operable to transmit signals to and to receive signals from other nodes (including the UE) via a network interface. A controller controls the operation of the AMF in accordance with software stored in a memory. Software may be pre-installed in the memory and/or may be downloaded via the telecommunication network or from a removable data storage device (RMD), for example. The software includes, among other things, an operating system and a communications control module having at least a transceiver control module.

The communications control module (using its transceiver control sub-module) is responsible for handling (generating/sending/receiving) signalling between the AMF and other nodes, such as the UE, base station/(R)AN node (e.g. “gNB” or “eNB”) (directly or indirectly). Such signalling may include, for example, appropriately formatted signalling messages relating to the procedures described herein, for example, NG AP message (i.e. a message by N2 reference point) to convey an NAS message from and to the UE, etc.

The User Equipment (or “UE”, “mobile station”, “mobile device” or “wireless device”) in the present disclosure is an entity connected to a network via a wireless interface.

It should be noted that the UE in this specification is not limited to a dedicated communication device, and can be applied to any device, having a communication function as a UE described in this specification, as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery.

It will be appreciated that the terms “UE” and “wireless device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE may support one or more IoT or MTC applications. Some examples of MTC applications are listed in the Table 3 (source: 3GPP TS 22.368, Annex B, the contents of which are incorporated herein by reference). This list is not exhaustive and is intended to be indicative of some examples of machine type communication applications.

TABLE 1
Some examples of machine-type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch eXchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary embodiments described in the present document. Needless to say, these technical ideas and embodiments are not limited to the above-described UE and various modifications can be made thereto.

The whole or part of the example embodiments disclosed above can be described as, but not limited to, the following.

### UDM Based Solution

### 6.1.2 Initiation of Authentication and Selection of Authentication Method

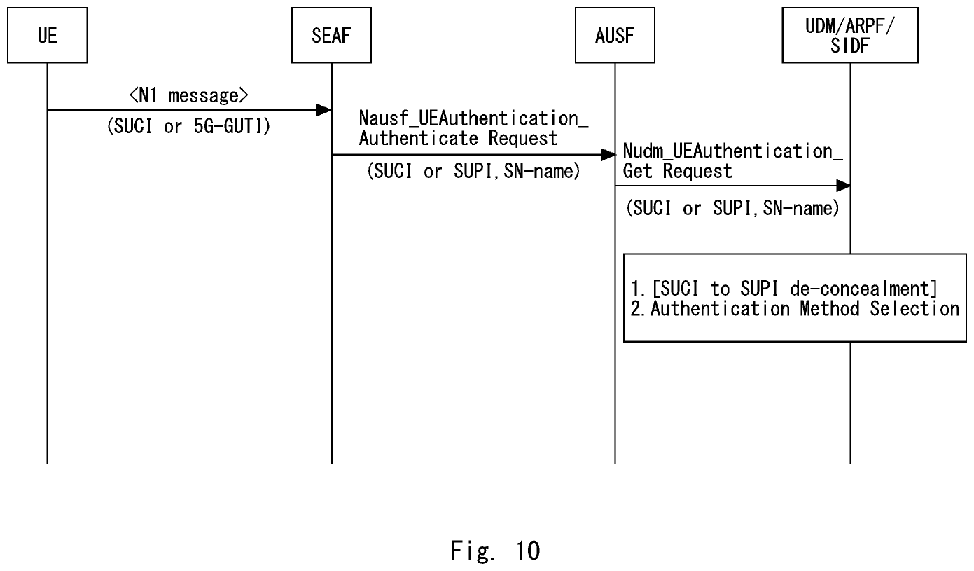

The initiation of the primary authentication is shown in Figure 6.1.2-1. (See FIG. 10 of the present application.)

Figure 6.1.2-1: Initiation of authentication procedure and selection of authentication method

The SEAF may initiate an authentication with the UE during any procedure establishing a signalling connection with the UE, according to the SEAF's policy. The UE shall use SUCI or 5G-GUTI in the Registration Request.

The SEAF shall invoke the Nausf_UEAuthentication service by sending a Nausf_UEAuthentication_Authenticate Request message to the AUSF whenever the SEAF wishes to initiate an authentication.

The Nausf_UEAuthentication_Authenticate Request message shall contain either:
SUCI, as defined in the current specification, or
SUPI, as defined in TS 23.501 [2].

The SEAF shall include the SUPI in the Nausf_UEAuthentication_Authenticate Request message in case the SEAF has a valid 5G-GUTI and re-authenticates the UE. Otherwise the SUCI is included in Nausf_UEAuthentication_Authenticate Request. SUPI/SUCI structure is part of stage 3 protocol design.

The Nausf_UEAuthentication_Authenticate Request shall furthermore contain:
the serving network name, as defined in sub-clause 6.1.1.4 of the present document.

NOTE 2: The local policy for the selection of the authentication method does not need to be on a per-UE basis, but can be the same for all UEs.

Upon receiving the Nausf_UEAuthentication_Authenticate Request message, the AUSF shall check that the requesting SEAF in the serving network is entitled to use the serving network name in the Nausf_UEAuthentication_Authenticate Request by comparing the serving network name with the expected serving network name. The AUSF shall store the received serving network name temporarily. If the serving network is not authorized to use the serving network name, the AUSF shall respond with “serving network not authorized” in the Nausf_UEAuthentication_Authenticate Response.

The Nudm_UEAuthentication_Get Request sent from AUSF to UDM includes the following information:
SUCI or SUPI;
the serving network name;

Upon reception of the Nudm_UEAuthentication_Get Request, the UDM shall invoke SIDF if a SUCI is received. SIDF shall de-conceal SUCI to gain SUPI before UDM can process the request.

Based on SUPI, the UDM/ARPF shall choose the authentication method.

NOTE 3: The Nudm_UEAuthentication_Get Response in reply to the Nudm_UEAuthentication_Get Request and the Nausf_UEAuthentication_Authenticate Response message in reply to the Nausf_UEAuthentication_Authenticate Request message are described as part of the authentication procedures in clause 6.1.3.

In order to detect a Man In the Middle (i.e. MITM) attack attempt, the UDM shall keep track of received SUCIs per SUPI for pre-defined period (ex. 24 hours). Upon reception of the Nudm_UEAuthentication_Get Request, the UDM shall de-conceal SUCI to a SUPI and perform one of the following action:
i) the UDM starts timer T3519 for a received SUCI if the UDM does not contain the SUCI for the SUPI and the T3519 is not running in the UDM and performs the authentication procedure as defined in sub clause 6.1.3.
ii) if the timer T3519 is running in the UDM for the SUCI of the SUPI, the UDM performs the authentication procedure as defined in the sub-clause 6.1.3.
iii) If the SUCI is already present in the UDM for the SUPI and timer T3519 for the SUCI is not running (i.e. expired) then the UDM shall reject the authentication procedure by sending Nudm_UEAuthentication_Get Response with cause set to illegal UE.

In addition, if the NWDAF determines that the MITM is in the network, the NWDAF informs it to the Operation and Maintenance (OAM) in order for the OAM to take some security actions.

### AMF Based Solution

### 6.1.2 Initiation of Authentication and Selection of Authentication Method

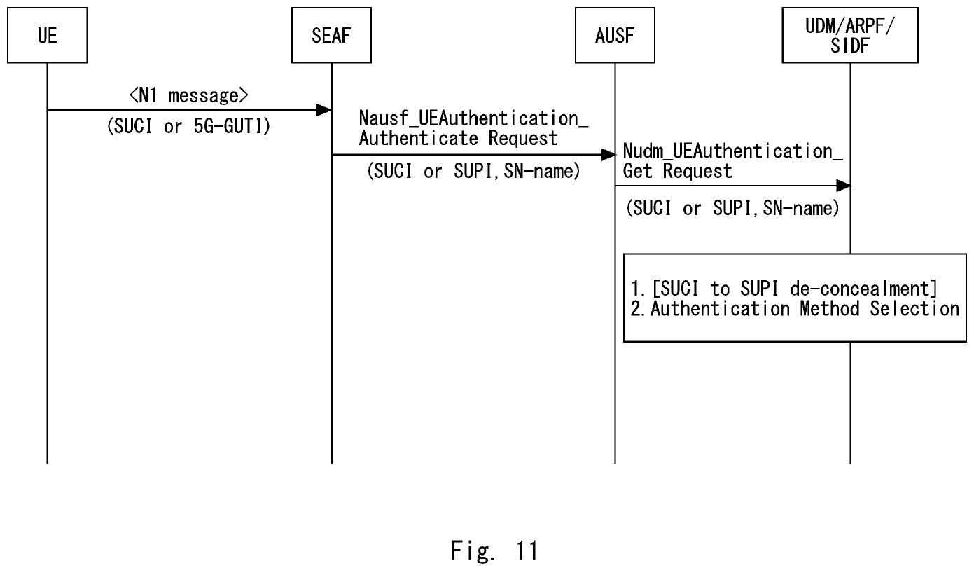

The initiation of the primary authentication is shown in Figure 6.1.2-1. (See FIG. 11 of the present application.)

Figure 6.1.2-1: Initiation of authentication procedure and selection of authentication method

The SEAF may initiate an authentication with the UE during any procedure establishing a signalling connection with the UE, according to the SEAF's policy. The UE shall use SUCI or 5G-GUTI in the Registration Request.

The SEAF shall invoke the Nausf_UEAuthentication service by sending a Nausf_UEAuthentication_Authenticate Request message to the AUSF whenever the SEAF wishes to initiate an authentication.

The Nausf_UEAuthentication_Authenticate Request message shall contain either:
SUCI, as defined in the current specification, or
SUPI, as defined in TS 23.501 [2].

The SEAF shall include the SUPI in the Nausf_UEAuthentication_Authenticate Request message in case the SEAF has a valid 5G-GUTI and re-authenticates the UE. Otherwise the SUCI is included in Nausf_UEAuthentication_Authenticate Request. SUPI/SUCI structure is part of stage 3 protocol design.

The Nausf_UEAuthentication_Authenticate Request shall furthermore contain:
the serving network name, as defined in sub-clause 6.1.1.4 of the present document.

NOTE 2: The local policy for the selection of the authentication method does not need to be on a per-UE basis, but can be the same for all UEs.

Upon receiving the Nausf_UEAuthentication_Authenticate Request message, the AUSF shall check that the requesting SEAF in the serving network is entitled to use the serving network name in the Nausf_UEAuthentication_Authenticate Request by comparing the serving network name with the expected serving network name. The AUSF shall store the received serving network name temporarily. If the serving network is not authorized to use the serving network name, the AUSF shall respond with “serving network not authorized” in the Nausf_UEAuthentication_Authenticate Response.

The Nudm_UEAuthentication_Get Request sent from AUSF to UDM includes the following information:
SUCI or SUPI;
the serving network name;

Upon reception of the Nudm_UEAuthentication_Get Request, the UDM shall invoke SIDF if a SUCI is received. SIDF shall de-conceal SUCI to gain SUPI before UDM can process the request.

Based on SUPI, the UDM/ARPF shall choose the authentication method.

NOTE 3: The Nudm_UEAuthentication_Get Response in reply to the Nudm_UEAuthentication_Get Request and the Nausf_UEAuthentication_Authenticate Response message in reply to the Nausf_UEAuthentication_Authenticate Request message are described as part of the authentication procedures in clause 6.1.3.

In order to detect a Man In the Middle (i.e. MITM) attack attempt, the AMF/SEAF shall keep track of received SUCIs for pre-defined period (ex. 24 hours) or when the AMF can't find UE contexts of a certain number of the based on the received 5G-GUTIs in the Initial NAS message or in the 5G-S-TMSI in Initial UE message, the AMF may start storing the SUCI received in the Identity response message. Upon reception of the registration request message or identity response message containing SUCI, the AMF/SEAF performs one of the following action:
i) the AMF/SEAF starts timer T3519 for a received SUCI if the AMF/SEAF does not contain the SUCI and the T3519 is not running in the AMF/SEAF for the SUCI and initiates the authentication procedure as defined in sub clause 6.1.3.
ii) if the timer T3519 is running in the AMF/SEAF for the SUCI, the AMF/SEAF initiates the authentication procedure as defined in the sub-clause 6.1.3.
iii) If the SUCI is already present in the AMF/SEAF and timer T3519 for the SUCI is not running (i.e. expired) then the AMF/SEAF shall reject the registration procedure or the initial NAS message by sending the response message (e.g. Registration Reject) with cause set to illegal UE. Additionally, the AMF informs NWDAF indicating MITM attack by sending a message containing (the SUCI, Global Cell ID, at least one parameter received in the Initial UE message or Initial NAS message. In addition, if the NWDAF determines that the MITM is in the network, the NWDAF informs it to the Operation and Maintenance (OAM) in order for the OAM to take some security actions.

### RAN Based Solution

### 5.3.3 RRC Connection Establishment

### 5.3.3.1 General

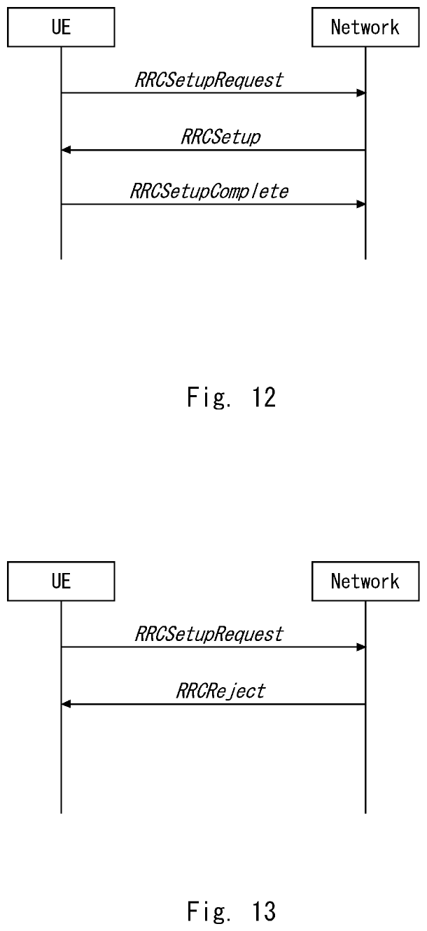

Figure 5.3.3.1-1: RRC connection establishment, successful. (See FIG. 12 of the present application.)

Figure 5.3.3.1-2: RRC connection establishment, network reject. (See FIG. 13 of the present application.)

The purpose of this procedure is to establish an RRC connection. RRC connection establishment involves SRB1 establishment. The procedure is also used to transfer the initial NAS dedicated information/message from the UE to the network.

The network applies the procedure e.g.as follows:
When establishing an RRC connection;
When UE is resuming or re-establishing an RRC connection, and the network is not able to retrieve or verify the UE context. In this case, UE receives RRCSetup and responds with RRCSetupComplete.

### 5.3.3.1a Conditions for Establishing RRC Connection for Sidelink Communication

For NR sidelink communication, an RRC connection establishment is initiated only in the following cases:
1> if configured by upper layers to transmit NR sidelink communication and related data is available for transmission:
2> if the frequency on which the UE is configured to transmit NR sidelink communication is included in sl-FreqInfoList within SIB12 provided by the cell on which the UE camps; and if the valid version of SIB12 does not include sl-TxPoolSelectedNormal for the concerned frequency;

For V2X sidelink communication, an RRC connection is initiated only when the conditions specified for V2X sidelink communication in subclause 5.3.3.1a of TS 36.331 [10] are met.

NOTE: Upper layers initiate an RRC connection. The interaction with NAS is left to UE implementation.

### 5.3.3.2 Initiation

The UE initiates the procedure when upper layers request establishment of an RRC connection while the UE is in RRC IDLE and it has acquired essential system information as described in 5.2.2.1, or for sidelink communication as specified in sub-clause 5.3.3.1a.

The UE shall ensure having valid and up to date essential system information as specified in clause 5.2.2.2 before initiating this procedure.

Upon initiation of the procedure, the UE shall:
1> if the upper layers provide an Access Category and one or more Access Identities upon requesting establishment of an RRC connection:
2> perform the unified access control procedure as specified in 5.3.14 using the Access Category and Access Identities provided by upper layers;
3> if the access attempt is barred, the procedure ends; 1> apply the default L1 parameter values as specified in corresponding physical layer specifications except for the parameters for which values are provided in SIB1;
1> apply the default MAC Cell Group configuration as specified in 9.2.2;
1> apply the CCCH configuration as specified in 9.1.1.2;
1> apply the timeAlignmentTimerCommon included in SIB1;
1> start timer T300;
1> initiate transmission of the RRCSetupRequest message in accordance with 5.3.3.3;
5.3.3.3 Actions Related to Transmission of RRCSetupRequest Message

The UE shall set the contents of RRCSetupRequest message as follows:
1> set the ue-Identity as follows:
2> if upper layers provide a 5G-S-TMSI:
3> set the ue-Identity to ng-5G-S-TMSI-Part1;
2> else:
3> draw a 39-bit random value in the range 0 . . . 2³⁹−1 and set the ue-Identity to this value;

NOTE 1: Upper layers provide the 5G-S-TMSI if the UE is registered in the TA of the current cell.
1> set the establishmentCause in accordance with the information received from upper layers;
The UE shall submit the RRCSetupRequest message to lower layers for transmission.

The UE shall continue cell re-selection related measurements as well as cell re-selection evaluation. If the conditions for cell re-selection are fulfilled, the UE shall perform cell re-selection as specified in 5.3.3.6.

5.3.3.4 Reception of the RRCSetup by the UE

The UE shall perform the following actions upon reception of the RRCSetup:
1> if the RRCSetup is received in response to an RRCReestablishmentRequest; or
1> if the RRCSetup is received in response to an RRCResumeRequest or RRCResumeRequest1:
2> discard any stored UE Inactive AS context and suspendConfig;
2> discard any current AS security context including the K_{RRCenc} key, the K_{RRCint} key, the K_{Upint} key and the K_{UPenc} key;
2> release radio resources for all established RBs except SRB0, including release of the RLC entities, of the associated PDCP entities and of SDAP;
2> release the RRC configuration except for the default L1 parameter values, default MAC Cell Group configuration and CCCH configuration;
2> indicate to upper layers fallback of the RRC connection; 2> stop timer T380, if running;
1> perform the cell group configuration procedure in accordance with the received masterCellGroup and as specified in 5.3.5.5;
1> perform the radio bearer configuration procedure in accordance with the received radioBearerConfig and as specified in 5.3.5.6;
1> if stored, discard the cell reselection priority information provided by the cellReselectionPriorities or inherited from another RAT;
1> stop timer T300, T301 or T319 if running;
1> if T390 is running:
2> stop timer T390 for all access categories;
2> perform the actions as specified in 5.3.14.4;
1> if T302 is running:
2> stop timer T302;
2> perform the actions as specified in 5.3.14.4;
1> stop timer T320, if running;
1> if the RRCSetup is received in response to an RRCResumeRequest, RRCResumeRequest1 or RRCSetupRequest:
2> if T331 is running:
3> stop timer T331;
3> perform the actions as specified in 5.7.8.3;
2> enter RRC_CONNECTED;
2> stop the cell re-selection procedure;
1> consider the current cell to be the PCell;
1> set the content of RRCSetupComplete message as follows:
2> if upper layers provide a 5G-S-TMSI:

3> if the RRCSetup is received in response to an RRCSetupRequest:
4> set the ng-5G-S-TMSI-Value to ng-5G-S-TMSI-Part2;
3> else:
4> set the ng-5G-S-TMSI-Value to ng-5G-S-TMSI;
2> set the selectedPLMN-Identity to the PLMN or SNPN selected by upper layers (TS 24.501 [23]) from the PLMN(s) included in the plmn-IdentityList or the PLMN(s) or SNPN(s) included in the npn-IdentityInfoList in SIB1;
2> if upper layers provide the ‘Registered AMF’:
3> include and set the registeredAMF as follows:
4> if the PLMN identity of the ‘Registered AMF’ is different from the PLMN selected by the upper layers:
5> include the plmnldentity in the registeredAMF and set it to the value of the PLMN identity in the ‘Registered AMF’ received from upper layers;
4> set the amf-Identifier to the value received from upper layers;
3> include and set the guami-Type to the value provided by the upper layers;
2> if upper layers provide one or more S-NSSAI (see TS 23.003 [21]):
3> include the s-NSSAI-List and set the content to the values provided by the upper layers;
2> set the dedicatedNAS-Message to include the information received from upper layers;
2> if connecting as an IAB-node:
3> include the iab-Nodelndication;
2> if the SIB1 contains idleModeMeasurementsNR and the UE has NR idle/inactive measurement information concerning cells other than the PCell available in VarMeasldleReport; or
2> if the SIB1 contains idleModeMeasurementsEUTRA and the UE has E-UTRA idle/inactive measurement information available in VarMeasldleReport:
3> include the idleMeasAvailable;
2> if the UE has logged measurements available for NR and if the RPLMN is included in plmn-IdentityList stored in VarLogMeasReport:
3> include the logMeasAvailable in the RRCSetupComplete message;
2> if the UE has Bluetooth logged measurements available and if the RPLMN is included in plmn-IdentityList stored in VarLogMeasReport:
3> include the logMeasAvailableBT in the RRCSetupComplete message;
2> if the UE has WLAN logged measurements available and if the RPLMN is included in plmn-IdentityList stored in VarLogMeasReport:
3> include the logMeasAvailableWLAN in the RRCSetupComplete message;
2> if the UE has connection establishment failure or connection resume failure information available in VarConnEstFailReport and if the RPLMN is equal to plmn-Identity stored in VarConnEstFailReport:
3> include connEstFaillnfoAvailable in the RRCSetupComplete message;
2> if the UE has radio link failure or handover failure information available in VarRLF-Report and if the RPLMN is included in plmn-IdentityList stored in VarRLF-Report:
3> if reconnectCellId in VarRLF-Report is not set:
4> set timeUntilReconnection in VarRLF-Report to the time that elapsed since the last radio link or handover failure;
4> set nrReconnectCellId in reconnectCellId in VarRLF-Report to the global cell identity and the tracking area code of the PCell;
3> include rlf-InfoAvailable in the RRCSetupComplete message;
2> if the UE supports RLF report for inter-RAT MRO NR as defined in TS 36.306 [62], and if the UE has radio link failure or handover failure information available in VarRLF-Report of TS 36.331 [10]:
3> if reconnectCellId in VarRLF-Report of TS 36.331[10] is not set:
4> set timeUntilReconnection in VarRLF-Report of TS 36.331[10] to the time that elapsed since the last radio link or handover failure in LTE;
4> set nrReconnectCellId in reconnectCellId in VarRLF-Report of TS 36.331[10] to the global cell identity and the tracking area code of the PCell;
3> if the UE is capable of cross-RAT RLF reporting and if the RPLMN is included in plmn-IdentityList stored in VarRLF-Report of TS 36.331
4> include rlf-InfoAvailable in the RRCSetupComplete message; 2> if the UE supports storage of mobility history information and the UE has mobility history information available in VarMobilityHistoryReport:
3> include the mobilityHistoryAvail in the RRCSetupComplete message; 2> if the RRCSetup is received in response to an RRCResumeRequest, RRCResumeRequest1 or RRCSetupRequest:
3> if speedStateReselectionPars is configured in the SIB2:
4> include the mobilityState in the RRCSetupComplete message and set it to the mobility state (as specified in TS 38.304 [20]) of the UE just prior to entering RRC_CONNECTED state;
1> submit the RRCSetupComplete message to lower layers for transmission, upon which the procedure ends.

5.3.3.5 Reception of the RRCSetupComplete by the Network

Upon reception of the RRCSetupComplete message by the network, the network compares the 5G-GUTI received during the RRC connection establishment and 5G-GUTI contained in the dedicatedNAS-Message, if they are identical, the network proceeds with the RRC connection establishment procedure otherwise the network discards the RRCSetupComplete message and releases the RRC connection locally.

The timer and the timer name (e.g. T3510, T3511 and T3519) as mentioned above are example. That is, another timer and another timer name may be used for processes in the above embodiments.

The whole or part of the example embodiments disclosed above can be described as, but not limited to, the following supplementary notes.

### Supplementary Note 1.

A method of a Radio Access Network (RAN) node, the method comprising:
receiving a Radio Resource Control (RRC) message,
wherein the RRC message includes a first identifier and a Non-Access-Stratum (NAS) message, and
wherein the NAS message includes a second identifier;
comparing the first identifier and the second identifier; and
discarding the RRC message in a case where the first identifier is different from the second identifier.

### Supplementary Note 2

The method according to supplementary note 1, wherein the first identifier and the second identifier are related to a user equipment (UE).

### Supplementary Note 3.

The method according to supplementary note 1 or 2, wherein the RAN node is a base station.

### Supplementary Note 4.

A method of a core network node, the method comprising:
receiving a message,
wherein the message includes a first identifier and a Non-Access-Stratum (NAS) message, and
wherein the NAS message includes a second identifier;
comparing the first identifier and the second identifier; and
discarding the NAS message in a case where the first identifier is different from the second identifier.

### Supplementary Note 5.

The method according to supplementary note 4,
wherein the first identifier and the second identifier are related to a user equipment (UE).

### Supplementary Note 6.

The method according to supplementary note 4 or 5, further comprising:
sending a message to request to discard a message including the second identifier in a case where the first identifier is different from the second identifier.

### Supplementary Note 7.

The method according to any one of supplementary notes 4 to 6,
wherein the core network node is a Access and Mobility Management Function (AMF).

### Supplementary Note 8.

A method of a core network node, the method comprising:
storing a first identifier;
receiving a message during a NAS procedure,
wherein the message includes a second identifier;
comparing the first identifier and the second identifier; and
aborting the NAS procedure in a case where the first identifier corresponds to the second identifier.

### Supplementary Note 9.

The method according to supplementary note 8,
wherein the core network node is a Access and Mobility Management Function (AMF).

### Supplementary Note 10.

The method according to supplementary note 8 or 9, further comprising:
wherein the first identifier is stored with a third identifier,
receiving a message including a fourth identifier;
comparing first combination of the first identifier and the third identifier, and second combination of the second identifier and the fourth identifier; and
aborting the NAS procedure in a case where the first combination corresponds to the second combination.

### Supplementary Note 11.

A method of a core network node, the method comprising:
receiving a first identifier;
starting a timer;
receiving a second identifier;
determining whether the second identifier is sent after the timer expires; and
sending a message to reject a NAS procedure in a case of determining that
the second identifier is sent after the timer expires.

### Supplementary Note 12.

A method of a core network node, the method comprising:
receiving a first identifier;
starting a timer;
receiving a second identifier;
determining whether the second identifier is sent within a timer value of the timer; and
sending a message to reject a NAS procedure in a case of determining that the second identifier is sent within the timer value of the timer.

### Supplementary Note 13.

A method of a core network node, the method comprising:
receiving a first identifier;
starting a timer;
determining whether the timer expires; and
sending a message to reject a NAS procedure in a case of determining that the timer expires.

### Supplementary Note 14.

The method according to any one of supplementary notes 11 to 13, wherein the core network node is a Network Data Analytics Function (NWDAF).

### Supplementary Note 15.

A method of a core network node, the method comprising:
storing a first identifier;
starting a timer;
receiving a message during an authentication procedure;
wherein the message includes a second identifier;
determining whether the first identifier corresponds to the second identifier and the timer is running; and
rejecting the authentication procedure in a case of determining that the first identifier corresponds to the second identifier and the timer is not running.

### Supplementary Note 16.

The method according to supplementary note 15, wherein the core network node is a Unified Data Management (UDM).

### Supplementary Note 17.

A Radio Access Network (RAN) node comprising:
means for receiving a Radio Resource Control (RRC) message, wherein the RRC message includes a first identifier and a Non-Access-Stratum (NAS) message, and
wherein the NAS message includes a second identifier;
means for comparing the first identifier and the second identifier; and
means for discarding the RRC message in a case where the first identifier is different from the second identifier.

### Supplementary Note 18.

The RAN node according to supplementary note 17,
wherein the first identifier and the second identifier are related to a user equipment (UE).

### Supplementary Note 19.

The RAN node according to supplementary note 17 or 18,
wherein the RAN node is a base station.

### Supplementary Note 20.

A core network node comprising:
means for receiving a message,
wherein the message includes a first identifier and a Non-Access-Stratum (NAS) message, and
wherein the NAS message includes a second identifier;
means for comparing the first identifier and the second identifier; and
means for discarding the NAS message in a case where the first identifier is different from the second identifier.

### Supplementary Note 21.

The core network node according to supplementary note 20,
wherein the first identifier and the second identifier are related to a user equipment (UE).

### Supplementary Note 22.

The core network node according to supplementary note 20 or 21, further comprising:
means for sending a message to request to discard a message including the second identifier in a case where the first identifier is different from the second identifier.

### Supplementary Note 23.

The core network node according to any one of supplementary notes 20 to 22,
wherein the core network node is a Access and Mobility Management Function (AMF).

### Supplementary Note 24.

A core network node comprising:
means for storing a first identifier;
means for receiving a message during a NAS procedure,
wherein the message includes a second identifier;
means for comparing the first identifier and the second identifier; and
means for aborting the NAS procedure in a case where the first identifier corresponds to the second identifier.

### Supplementary Note 25.

The core network node according to supplementary note 24,
wherein the core network node is a Access and Mobility Management Function (AMF).

### Supplementary Note 26.

The core network node according to supplementary note 24 or 25, further comprising:
wherein the first identifier is stored with a third identifier,
means for receiving a message including a fourth identifier;
means for comparing first combination of the first identifier and the third identifier, and second combination of the second identifier and the fourth identifier; and
aborting the NAS procedure in a case where the first combination corresponds to the second combination.

### Supplementary Note 27.

A core network node comprising:
means for receiving a first identifier;
means for starting a timer;
means for receiving a second identifier;
means for determining whether the second identifier is sent after the timer expires; and
means for sending a message to reject a NAS procedure in a case of determining that the second identifier is sent after the timer expires.

### Supplementary Note 28.

A core network node comprising:
means for receiving a first identifier;
means for starting a timer;
means for receiving a second identifier;
means for determining whether the second identifier is sent within a timer value of the timer; and
means for sending a message to reject a NAS procedure in a case of determining that the second identifier is sent within the timer value of the timer.

### Supplementary Note 29.

A core network node comprising:
means for receiving a first identifier;
means for starting a timer;
means for determining whether the timer expires; and
means for sending a message to reject a NAS procedure in a case of determining that the timer expires.

### Supplementary Note 30.

The core network node according to any one of supplementary notes 27 to 29,
wherein the core network node is a Network Data Analytics Function (NWDAF).

### Supplementary Note 31.

A core network node comprising:
means for storing a first identifier;
means for starting a timer;
means for receiving a message during an authentication procedure;
wherein the message includes a second identifier;
means for determining whether the first identifier corresponds to the second identifier;
means for determining whether the timer is running; and
means for rejecting the authentication procedure in a case of determining that the first identifier corresponds to the second identifier and the timer is not running.

### Supplementary Note 32.

The core network node according to supplementary note 31,
wherein the core network node is a Unified Data Management (UDM).

This application is based upon and claims the benefit of priority from Indian patent applications No. 202111000766, filed on Jan. 7, 2021, the disclosure of which is incorporated herein in its entirety by reference.

What is claimed is:

1. A method of a Radio Access Network (RAN) node, the method comprising:
receiving a Radio Resource Control (RRC) message,
wherein the RRC message includes a first identifier and a Non-Access-Stratum (NAS) message, and
wherein the NAS message includes a second identifier;
comparing the first identifier and the second identifier; and
discarding the RRC message in a case where the first identifier is different from the second identifier.

2. The method according to claim 1,
wherein the first identifier and the second identifier are related to a user equipment (UE).

3. The method according to claim 1,
wherein the RAN node is a base station.

4. A method of a core network node, the method comprising:
receiving a message,
wherein the message includes a first identifier and a Non-Access-Stratum (NAS) message, and
wherein the NAS message includes a second identifier;
comparing the first identifier and the second identifier; and
discarding the NAS message in a case where the first identifier is different from the second identifier.

5. The method according to claim 4,
wherein the first identifier and the second identifier are related to a user equipment (UE).

6. The method according to claim 4 or 5, further comprising:
sending a message to request to discard a message including the second identifier in a case where the first identifier is different from the second identifier.

7. The method according to claim 4,
wherein the core network node is an Access and Mobility Management Function (AMF).

8-16. (canceled)

17. A Radio Access Network (RAN) node comprising:
at least one memory; and
at least one hardware processor coupled to the at least one memory,
wherein the at least one hardware processor is configured to:
receive a Radio Resource Control (RRC) message,
wherein the RRC message includes a first identifier and a Non-Access-Stratum (NAS) message, and
wherein the NAS message includes a second identifier;
compare the first identifier and the second identifier; and
discard the RRC message in a case where the first identifier is different from the second identifier.

18-32. (canceled)
